(19) United States
(12) Patent Application Publication
(10) Pub. No.: US 2014/0133471 A1
(43) Pub. Date: May 15, 2014

(54) METHODS AND DEVICES RELATING TO MIMO COMMUNICATIONS

(71) Applicant: TELEFONAKTIEBOLAGET L M ERICSSON (PUBL), Stockholm (SE)

(72) Inventors: Sairamesh Nammi, Stockholm (SE); Bo Göransson, Sollentuna (SE); Anders Jonsson, Taby (SE); Namir Lidian, Solna (SE); Fredrik Ovesjö, Alvsjo (SE)

(21) Appl. No.: 13/822,090

(22) PCT Filed: Dec. 17, 2012
(86) PCT No.: PCT/SE2012/051406

§ 371 Date: Mar. 11, 2013

Related U.S. Application Data
(60) Provisional application No. 61/613,450, filed on Mar. 20, 2012.
(60) Provisional application No. 61/615,540, filed on Mar. 26, 2012.
(60) Provisional application No. 61/642,611, filed on May 4, 2012.

(51) Int. Cl. H04B 7/04; H04L 5/00

(52) U.S. Cl. CPC H04B 7/0417; H04L 5/0055
USPC 370/336

(57) ABSTRACT

Methods and devices supporting MIMO transmission/reception are discussed. For example, first and second data blocks may be transmitted/received respectively using first and second transmission/reception layers during a first TTI for rank two transmission/reception. A first HARQ process may be mapped to the first data block of the first layer for the first TTI. A second HARQ process may be mapped to the second data block of the second layer for the first TTI. Third, fourth, and fifth data blocks may be transmitted/received respectively using the first and second layers and using a third transmission/reception layer during a second TTI for rank three transmission/reception. The first HARQ process may be mapped to the third data block of the first layer for the second TTI. The second HARQ process may be mapped to the fourth and fifth data blocks of the second and third layers for the second TTI.

### TECHNICAL FIELD

The present disclosure is directed to wireless communications and, more particularly, to multiple-input-multiple-output (MIMO) wireless communications and related network nodes and wireless terminals.

### BACKGROUND

In a typical cellular radio system, wireless terminals (also referred to as user equipment unit nodes, UEs, and/or mobile stations) communicate via a radio access network (RAN) with one or more core networks. The RAN covers a geographical area which is divided into cell areas, with each cell area being served by a radio base station (also referred to as a RAN node, a “NodeB”, and/or enhanced NodeB “eNodeB”). A cell area is a geographical area where radio coverage is provided by the base station equipment at a base station site. The base stations communicate through radio communication channels with UEs within range of the base stations.

Moreover, a cell area for a base station may be divided into a plurality of sectors surrounding the base station. For example, a base station may service three 120 degree sectors surrounding the base station, and the base station may provide a respective directional transceiver and sector antenna array for each sector. Stated in other words, a base station may include three directional sector antenna arrays servicing respective 120 degree base station sectors surrounding the base station.

Multi-antenna techniques can significantly increase capacity, data rates, and/or reliability of a wireless communication system as discussed, for example, by Telatar in “Capacity Of Multi-Antenna Gaussian Channels” (European Transactions On Telecommunications, Vol. 10, pp. 585-595, November 1999). Performance may be improved if both the transmitter and the receiver for a base station sector are equipped with multiple antennas (e.g., a sector antenna array) to provide a multiple-input multiple-output (MIMO) communication channel(s) for the base station sector. Such systems and/or related techniques are commonly referred to as MIMO. The LTE standard is currently evolving with enhanced MIMO support and MIMO antenna deployments. A spatial multiplexing mode is provided for relatively high data rates in more favorable channel conditions, and a transmit diversity mode is provided for relatively high reliability (at lower data rates) in less favorable channel conditions.

In a downlink from a base station transmitting from a sector antenna array over a MIMO channel to a wireless terminal in the sector, for example, spatial multiplexing (or SM) may allow the simultaneous transmission of multiple symbol streams over the same frequency from the base station sector antenna array for the sector. Stated in other words, multiple symbol streams may be transmitted from the base station sector antenna array for the sector to the wireless terminal over the same downlink time/frequency resource element (TFRE) to provide an increased data rate. In a downlink from the same base station sector transmitting from the same sector antenna array to the same wireless terminal, transmit diversity (e.g., using space-time codes) may allow the simultaneous transmission of the same symbol stream over the same frequency from different antennas of the base station sector antenna array. Stated in other words, the same symbol stream may be transmitted from different antennas of the base station sector antenna array to the wireless terminal over the same time/frequency resource element (TFRE) to provide increased reliability of reception at the wireless terminal due to transmit diversity gain.

Four layer MIMO transmission schemes are proposed for High-Speed-Downlink-Packet-Access (HSDPA) within Third Generation Partnership Project (3GPP) standardization. Accordingly, up to 4 channel encoded transport data blocks (sometimes referred to as transport data block codewords) may be transmitted using a same TFRE when using 4-branch MIMO transmission. Because ACK/NACK signaling and/or channel encoding for each transport data block to be transmitted during a same TFRE may require wireless terminal feedback (e.g., as ACK/NACK and/or CQI or channel quality information), feedback to define ACK/NACK and/or channel encoding for 4 transport data blocks may be required when using 4-branch MIMO transmission. Feedback signaling when using 4-branch MIMO transmission may thus be undesirably high, for example, because different MIMO layers may be received at a wireless terminal during a same TFRE with different qualities, signal strengths, error rates, etc.

### SUMMARY

It may therefore be an object to address at least some of the above mentioned disadvantages and/or to improve performance in a wireless communication system. Some embodiments of present inventive concepts, for example, may provide improved gain(s) without significantly increasing delay(s).

According to some embodiments, methods may be provided to operate a communications device supporting multiple-input-multiple-output (MIMO) reception over a wireless channel. First and second data blocks may be received respectively using first and second reception layers during a first transmission time interval (TTI) for rank two reception. A first Hybrid Automatic Repeat Request (HARQ) process may be mapped to the first data block of the first reception layer for the first transmission time interval and a second HARQ process may be mapped to the second data block of the second reception layer for the first TTI. Third, fourth, and fifth data blocks may be received respectively using the first and second reception layers and using a third reception layers during a second TTI for rank three reception. The first HARQ process may be mapped to the third data block of the first reception layer for the second TTI and the second HARQ process may be mapped to the fourth and fifth data blocks of the second and third reception layers for the second TTI.

Sixth, seventh, eighth, and ninth data blocks may be received respectively using the first, second, and third receptions layers and using a fourth reception layers during a third TTI for rank four reception. The first HARQ process may be mapped to the sixth and ninth data blocks of the first and fourth reception layers for the third TTI and the second HARQ process may be mapped to the seventh and eighth data blocks of the second and third reception layers for the third TTI.

A tenth data block may be received using the first reception layer during a fourth transmission time interval for rank one reception, and the first HARQ process may be mapped to the tenth data block of the first reception layer for the fourth transmission time interval.

The communication device may be a wireless terminal.

Mapping the first HARQ process to the first data block of the first TTI may include transmitting an acknowledgment (ACK) message to the radio access network responsive to success decoding the first data block and transmitting a non-acknowledgment (NACK) message to the radio access network responsive to failure decoding the first data block. Mapping the second HARQ process to the second data block for the first TTI may include transmitting an ACK message to the radio access network responsive to success decoding the second data block and transmitting a NACK message to the radio access network responsive to failure decoding the second data block.

A precoding vector may be selected responsive to success and/or failure decoding the first and second data blocks, and an identification of the selected precoding vector may be transmitted to the radio access network.

Selecting may include defining a search space for precoding vectors to include a plurality of precoding vectors of a precoding code book responsive to success decoding all of the first and second data blocks received during the first transmission time interval, defining a search space for precoding vectors to include fewer than all of the plurality of precoding vectors of the precoding codebook responsive to failure decoding at least one of the first and second data blocks during the first transmission time interval, and selecting the precoding vector from the defined search space.

Mapping the first HARQ process to the third data block of the second TTI may include transmitting an ACK message to the radio access network responsive to success decoding the third data block and transmitting a NACK message responsive to failure decoding the third data block. Mapping the second HARQ process to the fourth and fifth data blocks of the second transmission time interval may include transmitting an ACK message to the radio access network responsive to success decoding both of the fourth and fifth data blocks and transmitting a NACK message responsive to failure decoding either or both of the fourth and fifth data blocks.

The communication device may be a wireless terminal. Mapping the first HARQ process to the sixth and ninth data blocks of the third TTI may include transmitting an ACK message to the radio access network responsive to success decoding both of the sixth and ninth data blocks and transmitting a NACK message to the radio access network responsive to failure decoding either or both of the sixth and ninth data blocks. Mapping the second HARQ process to the seventh and eighth data blocks of the third transmission time interval may include transmitting an ACK message to the radio access network responsive to success decoding both of the seventh and eighth data blocks and transmitting a NACK message to the radio access network responsive to failure decoding either or both of the seventh and eighth data blocks.

The first, second, third, and fourth reception layers may be defined including respective first, second, third, and fourth channel decoders.

According to some other embodiments, methods may be provided to operate a communication device receiving communications over a wireless channel. At least one data block may be received from a second communication device during a transmission time interval (TTI) over at least one of a plurality of reception layers. Responsive to success decoding all of the at least one data blocks received during the transmission time interval, a search space may be defined for precoding vectors to include a plurality of precoding vectors of a precoding codebook. Responsive to failure decoding at least one of the at least one data blocks during the transmission time interval, a search space may be defined for precoding vectors to include fewer than all of the plurality of precoding vectors of the precoding codebook. One of the precoding vectors may be selected from the defined search space. An identification of the selected precoding vector may be transmitted to the second communication device.

The plurality of precoding vectors of the precoding codebook may be grouped into respective ranks wherein each rank corresponds to a number of reception layers used to receive respective data blocks during a transmission time interval.

Defining the search space to include the plurality of precoding vectors may include defining the search space to include all of the ranks of precoding vectors, and defining the search space to include fewer than all of the precoding vectors may include restricting the search space to fewer than all of the ranks of precoding vectors.

The precoding codebook may include a first rank of precoding vectors for reception using only a first reception layer to receive only one data block during a rank one transmission time interval, a second rank of precoding vectors for reception using only first and second reception layers to receive only two data blocks during a rank two transmission time interval, a third rank of precoding vectors for reception using only first, second, and third reception layers to receive only three data blocks during a rank three transmission time interval, and a fourth rank of precoding vectors for reception using first, second, third, and fourth reception layers to receive four data blocks during a rank four transmission time interval.

Selecting one of the precoding vectors may include computing a performance of each of the precoding vectors of the defined search space, and selecting one of the precoding vectors may include selecting one of the precoding vectors from the defined search space responsive to the computed performances.

Defining the search space to include fewer than all of the plurality of precoding vectors may include excluding some of the plurality of precoding vectors from the defined search space.

The plurality of multiple-input-multiple-output (MIMO) reception layers with each of the MIMO reception layers may be defined including a respective channel decoder.

According to still other embodiments, a communications device may include a transceiver configured to receive multiple-input-multiple-output (MIMO) reception over a wireless channel, and a processor coupled to the transceiver.

The processor may be configured to receive first and second data blocks through the transceiver respectively using first and second reception layers during a first transmission time interval (TTI) for rank two reception, and to map a first Hybrid Automatic Repeat Request (HARQ) process to the first data block of the first reception layer for the first transmission time interval, and to map a second HARQ process to the second data block of the second reception layer for the first TTI. The processor may be further configured to receive third, fourth, and fifth data blocks through the transceiver respectively using the first and second reception layers and a third reception layers during a second TIT for rank three reception, to map the first HARQ process to the third data block of the first reception layer for the second TTI, and to map the second HARQ process to the fourth and fifth data blocks of the second and third reception layers for the second TTI.

The processor may be configured to receive sixth, seventh, eighth, and ninth data blocks respectively using the first, second, and third reception layers and a fourth reception layer during a third TTI for rank four reception, to map the first HARQ process to the sixth and ninth data blocks of the first and fourth reception layers for the third TTI, and to map the second HARQ process to the seventh and eighth data blocks of the second and third reception layers for the third TTI.

The communication device may be a wireless terminal.

The transceiver and/or the processor may define the first, second, third, and fourth reception layers including respective first, second, third, and fourth channel decoders.

According to still other embodiments, a communication device may include a transceiver configured to receive multiple-input-multiple-output (MIMO) communications over a wireless channel, and a processor coupled to the transceiver. The processor may be configured to receive at least one data block through the transceiver from a second communication device over at least one of a plurality of MIMO reception layers during a transmission time interval, to define a search space for precoding vectors to include a plurality of precoding vectors of a precoding code book responsive to success decoding all of the at least one data blocks received during the transmission time interval, to define a search space for precoding vectors to include fewer than all of the plurality of precoding vectors of the precoding codebook responsive to failure decoding at least one of the at least one data blocks during the transmission time interval, to select one of the precoding vectors from the defined search space, and to transmit an identification of the selected precoding vector through the transceiver to the second communication device.

The processor and/or the transceiver may define a plurality of multiple-input-multiple-output (MIMO) reception layers with each of the reception layers including a respective channel decoder.

According to yet other embodiments, a method may be provided to operate a communications device supporting multiple-input-multiple-output (MIMO) transmission over a wireless channel. A first Hybrid Automatic Repeat Request (HARQ) process may be mapped to a first data block of a first transmission layer for a first transmission time interval (TTI) and mapping a second HARQ process to a second data block of a second transmission layer for the first TTI. The first and second data blocks may be transmitted respectively using the first and second transmission layers during the first TTI for the rank two transmission. The first HARQ process may be mapped to a third data block of the first transmission layer for a second TTI and the second HARQ process may be mapped to fourth and fifth data blocks of the second transmission layer and a third transmission layer for the second TTI. The third, fourth, and fifth data blocks may be transmitted respectively using the first, second, and third transmission layers during the second TTI for the rank three transmission.

The first HARQ process may be mapped to sixth and ninth data blocks of the first transmission layer and a fourth transmission layer for a third TTI and the second HARQ process may be mapped to seventh and eighth data blocks of the second and third transmission layers for the third TTI for a rank four transmission. The sixth, seventh, eighth, and ninth data blocks may be transmitted respectively using the first, second, third, and fourth transmission layers during the third TTI for the rank four transmission.

The first HARQ process may be mapped to a tenth data block of the first transmission layer for a fourth TTI for a rank one transmission, and the tenth data block may be transmitted using the first transmission layer during the fourth transmission time interval for the rank one transmission.

The communication device may be a base station.

Mapping the first HARQ process to the first data block of the first TTI may include transmitting a single bit data indicator indicating an initial transmission or a retransmission of the first data block, and mapping the second HARQ process to the second data block of the first TTI may include transmitting a single bit data indicator indicating an initial transmission or a retransmission of the second data block.

Mapping the first HARQ process to the third data block of the second TTI may include transmitting a single bit data indicator indicating an initial transmission or a retransmission of the third data block, and mapping the second HAR process to the fourth and fifth data blocks of the second TTI may include transmitting a single bit data indicator indicating an initial transmission or a retransmission of the fourth and fifth data blocks.

Mapping the first HARQ process to the sixth and ninth data blocks of the third TTI may include transmitting a single bit data indicator indicating an initial transmission or a retransmission of the sixth and ninth data blocks, and mapping the second HARQ process to the seventh and eighth data blocks of the third TTI may include transmitting a single bit data indicator indicating an initial transmission or a retransmission of the seventh and eighth data blocks.

The first, second, third, and fourth transmission layers may be defined including respective first, second, third, and fourth channel encoders.

According to more embodiments, a communications device may include a transceiver configured to transmit multiple-input-multiple-output (MIMO) transmissions over a wireless channel, and a processor coupled to the transceiver.

The processor may be configured to transmit first and second data blocks through the transceiver respectively using first and second transmission layers during a first transmission time interval (TTI) for rank two transmission, to map a first Hybrid Automatic Repeat Request (HARQ) process to the first data block of the first transmission layer for the first transmission time interval, and to map a second HARQ process to the second data block of the second transmission layer for the first TTI. The processor may be further configured to transmit third, fourth, and fifth data blocks through the transceiver respectively using the first and second transmission layers and a third transmission layer during a second TTI for rank three transmission, to map the first HARQ process to the third data block of the first transmission layer for the second TTI, and to map the second HARQ process to the fourth and fifth data blocks of the second and third transmission layers for the second TTI.

The processor may be configured to transmit sixth, seventh, eighth, and ninth data blocks respectively using the first, second, and third transmission layers and a fourth transmission layer during a third TTI for rank four transmission, to map the first HARQ process to the sixth and ninth data blocks of the first and fourth transmission layers for the third TTI, and to map the second HARQ process to the seventh and eighth data blocks of the second and third transmission layers for the third TTI.

The communication device may be a base station.

The transceiver and/or the processor may define the first, second, third, and fourth transmission layers including respective first, second, third, and fourth channel encoders.

According to some embodiments of present inventive concepts, a method of operating a first communication device may include: defining a plurality of reception layers with each of the reception layers including a respective channel decoder; receiving at least one data block from a second communication device during a transmission time interval over at least one of the plurality of reception layers; responsive to success decoding all of the at least one data blocks received during the transmission time interval, considering a plurality of precoding vectors of a precoding code book; responsive to failure decoding at least one of the at least one data blocks during the transmission time interval, considering fewer than all of the plurality of precoding vectors of the precoding codebook; selecting one of the considered precoding vectors of the defined search space; and transmitting an identification of the selected precoding vector to the second communication device.

The plurality of precoding vectors of the precoding codebook may be grouped according to respective ranks wherein each rank corresponds to a number of reception layers used to receive respective data blocks during a transmission time interval. With four reception layers, for example, a first rank of precoding vectors may be provided for reception using only a first reception layer to receive only one data block during a rank one transmission time interval; a second rank of precoding vectors may be provided for reception using only first and second reception layers to receive only two data blocks during a rank two transmission time interval; a third rank of precoding vectors may be provided for reception using only first, second, and third reception layers to receive only three data blocks during a rank three transmission time interval; and a fourth rank of precoding vectors may be provided for reception using first, second, third, and fourth reception layers to receive four data blocks during a rank four transmission time interval.

Considering the plurality of precoding vectors of the precoding codebook may include defining a search space for precoding vectors to include a plurality of precoding vectors of a precoding code book and computing a performance of each of the precoding vectors of the defined search space. Considering fewer than all of the plurality of precoding vectors of the precoding codebook may include defining the search space for precoding vectors to include fewer than all of the plurality of precoding vectors of a precoding code book and computing a performance of each of the precoding vectors of the defined search space. Selecting one of the considered precoding vectors may include selecting responsive to the computed performances. If at least one of the data blocks received during the transmission time interval is not successfully decoded, for example, one or more of the ranks of precoding vectors may be excluded from consideration.

According to some embodiments of present inventive concepts, a method of operating a communications device supporting MIMO transmission/reception may include: defining first, second, third, and fourth transmission/reception layers including respective first, second, third, and fourth channel encoders/decoders; transmitting/receiving first and second data blocks respectively using the first and second transmission/reception layers during a first transmission time interval for rank two transmission/reception without using the third, and fourth transmission/reception layers wherein a first HARQ process is mapped to the first data block of the first transmission/reception layer for the first transmission time interval and wherein a second HARQ process is mapped to the second data block of the second transmission/reception layer for the first transmission time interval; transmitting/receiving third, fourth, and fifth data blocks respectively using the first, second, and third transmission/reception layers during a second transmission time interval for rank three transmission/reception without using the fourth transmission/reception layer wherein the first HARQ process is mapped to the third data block of the first transmission/reception layer for the second transmission time interval and wherein the second HARQ process is mapped to the fourth and fifth data blocks of the second and third transmission/reception layers for the second transmission time interval; and transmitting/receiving sixth, seventh, eighth, and ninth data blocks respectively using the first, second, third, and fourth transmission/reception layers during a third transmission time interval for rank four transmission/reception wherein the first HARQ process is mapped to the sixth and ninth data blocks of the first and fourth transmission/reception layers for the third transmission time interval and wherein the second HARQ process is mapped to the seventh and eighth data blocks of the second and third transmission/reception layers for the third transmission time interval.

In addition, a tenth data block may be transmitted/received using the first transmission/reception layer during a fourth transmission time interval for rank one transmission/reception without using the second, third, and fourth transmission/reception layers wherein the first HARQ process is mapped to the tenth data block of the first transmission/reception layer for the fourth transmission time interval. In an alternative, a tenth data block may be transmitted/received using the second transmission/reception layer during a fourth transmission time interval for rank one transmission/reception without using the first, third, and fourth transmission/reception layers wherein the first second HARQ process is mapped to the tenth data block of the second transmission/reception layer for the fourth transmission time interval.

The communication device may be a wireless terminal, the first, second, third, and fourth transmission/reception layers may be respective first, second, third, and fourth reception layers, and transmitting/receiving may comprising receiving. Mapping the first HARQ process to the first data block of the first transmission time interval may include generating an ACK responsive to success decoding the first data block and generating a NACK responsive to failure decoding the first data block, and mapping the second HARQ process to the second data block for the first transmission time interval may include generating an ACK responsive to success decoding the second data block and generating a NACK responsive to failure decoding the second data block. Mapping the first HARQ process to the third data block of the first transmission/reception layer for the second transmission time interval may include generating an ACK responsive to success decoding the third data block and generating a NACK responsive to failure decoding the third data block; and mapping the second HARQ process to the fourth and fifth data blocks of the second and third transmission/reception layers for the second transmission time interval may include generating an ACK responsive to success decoding both of the fourth and fifth data blocks and generating a NACK responsive to failure decoding either or both of the fourth and fifth data blocks. Mapping the first HARQ process to the sixth and ninth data blocks of the first and fourth transmission/reception layers for the third transmission time interval may include generating an ACK responsive to success decoding both of the sixth and ninth data blocks and generating a NACK responsive to failure decoding either or both of the sixth and ninth data blocks; and mapping the second HARQ process to the seventh and eighth data blocks of the second and third transmission/reception layers for the second transmission time interval may include generating an ACK responsive to success decoding both of the seventh and eighth data blocks and generating a NACK responsive to failure decoding either or both of the seventh and eighth data blocks.

### BRIEF DESCRIPTION OF THE DRAWINGS

The accompanying drawings, which are included to provide a further understanding of the disclosure and are incorporated in and constitute a part of this application, illustrate certain non-limiting embodiment(s) of inventive concepts. In the drawings:

FIG. 1 is a block diagram of a communication system that is configured according to some embodiments;

FIG. 2 is a block diagram illustrating a base station and a wireless terminal according to some embodiments of FIG. 1;

FIG. 3A is a message sequence chart for a MIMO communication system;

FIG. 3B is illustrates a feedback channel report format of FIG. 3A;

FIG. 3C is a timing diagram illustrating a round trip time between a downlink data transmission (transmitted via HS-PDSCH) and reception of a corresponding HARQ codeword response (including a HARQ ACK/NACK message) at a base station (received via HS-DPCCH) of FIG. 1;

FIG. 4 is a block diagram illustrating elements/functionalities of base station processors according to some embodiments of FIG. 2;

FIG. 5 is a block diagram illustrating elements/functionalities of wireless terminal processors according to some embodiments of FIG. 2;

FIG. 6 illustrates schematically a medium access control (MAC) entity in a wireless terminal (UE);

FIGS. 7A, 7B, and 7C are tables illustrating allocations of two HARQ processes to MIMO data layers/streams for rank 1, 2, 3, and 4 MIMO transmission/reception according to some alternative embodiments;

FIGS. 8A and 8B are flow charts illustrating operations of base stations and wireless terminals according to some embodiments;

FIG. 9 is a flow chart illustrating wireless terminal operations according to some embodiments;

FIGS. 10A, 10B, and 10C are tables illustrating MIMO rank selection respectively corresponding to embodiments of FIGS. 7A, 7B, and 7C; and

FIGS. 11 and 12 are flow charts illustrating operations of wireless terminals and base stations according to some embodiments.

### DETAILED DESCRIPTION

Inventive concepts will now be described more fully hereinafter with reference to the accompanying drawings, in which examples of embodiments of inventive concepts are shown. These inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

For purposes of illustration and explanation only, these and other embodiments of present inventive concepts are described herein in the context of operating in a RAN that communicates over radio communication channels with wireless terminals (also referred to as UEs). It will be understood, however, that present inventive concepts are not limited to such embodiments and may be embodied generally in any type of communication network. As used herein, a wireless terminal (also referred to as a UE) can include any device that receives data from a communication network, and may include, but is not limited to, a mobile telephone (“cellular” telephone), laptop/portable computer, pocket computer, hand-held computer, and/or desktop computer.

In some embodiments of a RAN, several base stations can be connected (e.g., by landlines or radio channels) to a radio network controller (RNC). The radio network controller, also sometimes termed a base station controller (BSC), supervises and coordinates various activities of the plural base stations connected thereto. The radio network controller is typically connected to one or more core networks.

The Universal Mobile Telecommunications System (UMTS) is a third generation mobile communication system, which evolved from the Global System for Mobile Communications (GSM), and is intended to provide improved mobile communication services based on Wideband Code Division Multiple Access (WCDMA) technology. UTRAN, short for UMTS Terrestrial Radio Access Network, is a collective term for the Node B's and Radio Network Controllers which make up the UMTS radio access network. Thus, UTRAN is essentially a radio access network using wideband code division multiple access for UEs.

The Third Generation Partnership Project (3GPP) has undertaken to further evolve the UTRAN and GSM based radio access network technologies. In this regard, specifications for the Evolved Universal Terrestrial Radio Access Network (E-UTRAN) are ongoing within 3GPP. The Evolved Universal Terrestrial Radio Access Network (E-UTRAN) comprises the Long Term Evolution (LTE) and System Architecture Evolution (SAE).

Note that although terminology from 3GPP (3^{rd} Generation Partnership Project) LTE (Long Term Evolution) is used in this disclosure to exemplify embodiments of inventive concepts, this should not be seen as limiting the scope of inventive concepts to only these systems. Other wireless systems, including WCDMA (Wideband Code Division Multiple Access), WiMax (Worldwide Interoperability for Microwave Access), UMB (Ultra Mobile Broadband), HSDPA (High-Speed Downlink Packet Access), GSM (Global System for Mobile Communications), etc., may also benefit from exploiting embodiments of present inventive concepts disclosed herein.

Also note that terminology such as base station (also referred to as eNodeB or Evolved Node B) and wireless terminal (also referred to as UE or User Equipment) should be considering non-limiting and does not imply a certain hierarchical relation between the two. In general a base station (e.g., an “eNodeB”) and a wireless terminal (e.g., a “UE”) may be considered as examples of respective different communications devices that communicate with each other over a wireless radio channel. While embodiments discussed herein may focus on wireless transmissions in a downlink from an eNodeB to a UE, embodiments of inventive concepts may also be applied, for example, in the uplink.

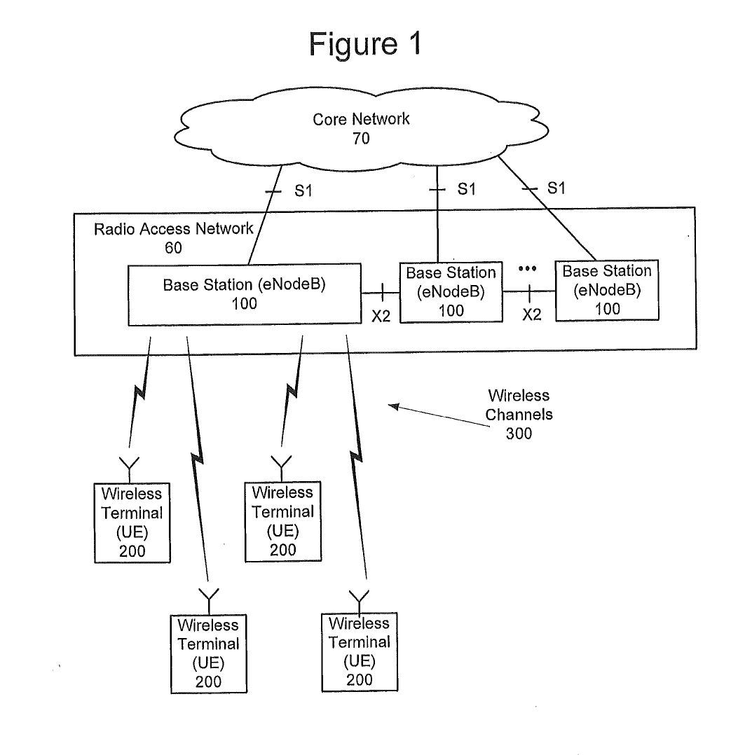

FIG. 1 is a block diagram of a communication system that is configured to operate according to some embodiments of present inventive concepts. An example RAN 60 is shown that may be a Long Term Evolution (LTE) RAN. Radio base stations (e.g., eNodeBs) 100 may be connected directly to one or more core networks 70, and/or radio base stations 100 may be coupled to core networks 70 through one or more radio network controllers (RNC). In some embodiments, functionality of a radio network controller(s) may be performed by radio base stations 100. Radio base stations 100 communicate over wireless channels 300 with wireless terminals (also referred to as user equipment nodes or UEs) 200 that are within their respective communication service cells (also referred to as coverage areas). The radio base stations 100 can communicate with one another through an X2 interface and with the core network(s) 70 through S1 interfaces, as is well known to one who is skilled in the art.

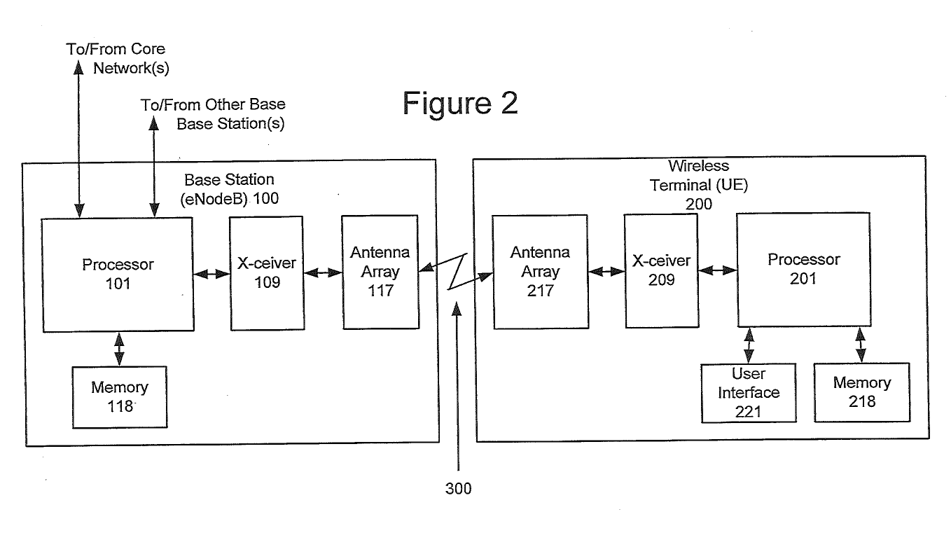

FIG. 2 is a block diagram of a base station 100 and a wireless terminal 200 of FIG. 1 in communication over wireless channel 300 according to some embodiments of present inventive concepts. As shown, base station 100 may include transceiver 109 coupled between processor 101 and antenna array 117 (including multiple antennas), and memory 118 coupled to processor 101. Moreover, wireless terminal 200 may include transceiver 209 coupled between antenna array 217 and processor 201, and user interface 221 and memory 218 may be coupled to processor 201. Accordingly, base station processor 101 may transmit communications through transceiver 109 and antenna array 117 for reception at wireless terminal processor 201 through antenna array 217 and transceiver 209. In the other direction, wireless terminal processor 201 may transmit communications through transceiver 209 and antenna array 217 for reception at base station processor 101 through antenna array 117 and transceiver 109. To support up to 4-branch MIMO (allowing parallel transmission of 4 layers/streams of data using a same TFRE), each of antenna arrays 117 and 217 may include four (or more) antenna elements. Wireless terminal 200 of FIG. 2, for example, may be a cellular radiotelephone, a smart phone, a laptop/netbook/tablet/handheld computer, or any other device providing wireless communications. User interface 211, for example, may include a visual display such as an liquid crystal display, a touch sensitive visual display, a keypad, a speaker, a microphone, etc.

For MIMO downlink transmissions from RAN 60 to wireless terminal 200, a codebook of precoding vectors (known at both RAN 60 and wireless terminal 200) is used to precode (e.g., to apply precoding weights to) the different data layers (data streams) that are transmitted in parallel from a sector antenna array(s) to the wireless terminal 200 during a same TFRE, and to decode the data layers (data streams) received in parallel during the same TFRE at wireless terminal 200. The same codebook of precoding vectors may be stored in wireless terminal memory 218 and in base station memory 118. Moreover, wireless terminal 200 may estimate characteristics of each downlink channel to generate channel quality information (CQI), and CQI feedback from wireless terminal 200 may be transmitted to base station 100. This CQI feedback may then be used by the base station processor 101 to select: transmission rank (i.e., a number of data layers/streams to be transmitted during a subsequent TFRE); transport data block length(s); channel code rate(s) to be used to channel encode different transport data blocks; modulation order(s); symbol to layer mapping schemes; and/or precoding vectors for respective downlink transmissions to the wireless terminal 200.

By way of example, base station antenna array 117 may include 4 antennas and wireless terminal antenna array 217 may include four antennas so that wireless terminal 200 may receive up to four downlink data layers (data streams) from base station antenna array 117 during MIMO communications. In this example, the precoding codebook may include rank 1 precoding vectors (used when transmitting one downlink data stream from a base station sector antenna array 117 to wireless terminal 200), rank 2 precoding vectors (used when transmitting two downlink data streams from a base station sector antenna array 117 to wireless terminal 200), rank 3 precoding vectors (used when transmitting three downlink data streams from a base station sector antenna array 117 to wireless terminal 200), and rank 4 precoding vectors (used when transmitting four downlink data streams from a base station sector antenna array 117 to wireless terminal 200). Precoding vectors may also be referred to, for example, as precoding codebook entries, precoding codewords, and/or precoding matrices.

An issue for four layer MIMO transmission schemes for HSDPA is what number of HARQ (Hybrid Automatic Repeat Request) codewords/processes should be supported. To reduce uplink and/or downlink signaling, two HARQ codewords/processes may be used in four layer MIMO transmission schemes for feedback relating to one, two, three, and four layer downlink transmissions. Use of two HARQ codewords/processes may be relatively easier to implement without significantly reducing performance (relative to use of four HARQ codewords/processes).

A Hybrid Automatic Repeat Request (HARQ) process(es) may be used in a wireless system to overcome transmission errors that cannot be corrected using a forward error correction code (also referred to as a channel code) alone. In some embodiments of a HARQ process, the HARQ process is mapped to one or more transmission layers, and the transmitting device (e.g., base station 100) attaches an error detection/correction code (e.g., a cyclic redundancy check or CRC code) to each transport data block (also referred to as a data block, data packet, packet, etc.) of a TTI/TFRE to provide error detection/correction, and the resulting data block including the error detection/correction code may be referred to as a data codeword CW. At the receiving device (e.g., at wireless terminal 200), the contents of each received transport data block may be validated using the respective error detection/correction code attached thereto. If the transport data block fails the error detection/correction validation, the receiving device may send a HARQ codeword including a negative acknowledgement NACK message (also referred to as a non-acknowledgement message) for the HARQ process back to the transmitting device to request a retransmission of the failed transport data block or blocks mapped to the HARQ process. A failed data block may be retransmitted until it is either decoded or until a maximum number of allowed retransmissions (e.g., four to six retransmissions) have occurred. If the transport data block passes the error detection/correction validation, a HARQ codeword including an acknowledgement ACK message for the HARQ process is sent back to the transmitting device to acknowledge reception and correct decoding of the transport data block. A HARQ process may thus be mapped to one or more MIMO transmission layers, and for each TTI/TFRE, the HARQ process may generate a HARQ ACK/NACK feedback message that is transmitted in a HARQ codeword of the feedback channel (e.g., HS-PDCCH).

As discussed in greater detail below, a wireless terminal 200 implementing HARQ functionality may include a soft buffer for each transport data block received during a TFRE so that originally transmitted and retransmitted transport data blocks may be combined before decoding to thereby improve system throughput. Depending on the way the originally transmitted and retransmitted transport data blocks are combined, HARQ systems/processes may be classified as chase combining or CC (retransmitting the same transport data block without additional information) or Incremental Redundancy or IR (transmitting the same transport data block with additional parity bits).

A single soft buffer may be used for layer/rank one MIMO transmission/reception (with one transport data block received during a TFRE), two soft buffers may be used for layer/rank two MIMO transmission/reception (with two transport data blocks received during a TFRE), three soft buffers may be used for layer/rank three MIMO transmission/reception (with three transport data blocks received during a TFRE), and four soft buffers may be used for layer/rank four MIMO transmission/reception (with four transport data blocks received during a TFRE). Each soft buffer stores a demodulator output for a transport data block before decoding to be used after a retransmission if the transport data block is not successfully decoded. For Release 7 MIMO supporting up to two rank/layer transmissions (with up to two transport data blocks transmitted to a UE during a TFRE), a HARQ process is provided for each soft buffer and thus for each transport data block. When two HARQ processes are mapped to three or four layer/rank MIMO transmission/reception, however, a mechanism to map UE receiver soft buffers to HARQ processes may be needed.

According to some embodiments discussed herein, methods may be provided to map functionalities between base station 100 transmission layers, wireless terminal 200 receiver layers (including respective soft buffers), and HARQ processes for situations when the number of supported HARQ processes is less than a number of MIMO transmission layers/ranks supported by the system (e.g., when rank/layer 3 and/or 4 MIMO transmissions are supported but only two HARQ processes are supported). With two HARQ processes, both HARQ ACK/NACK messages may be included in a HARQ codeword of the feedback channel (e.g., HS-DPCCH).

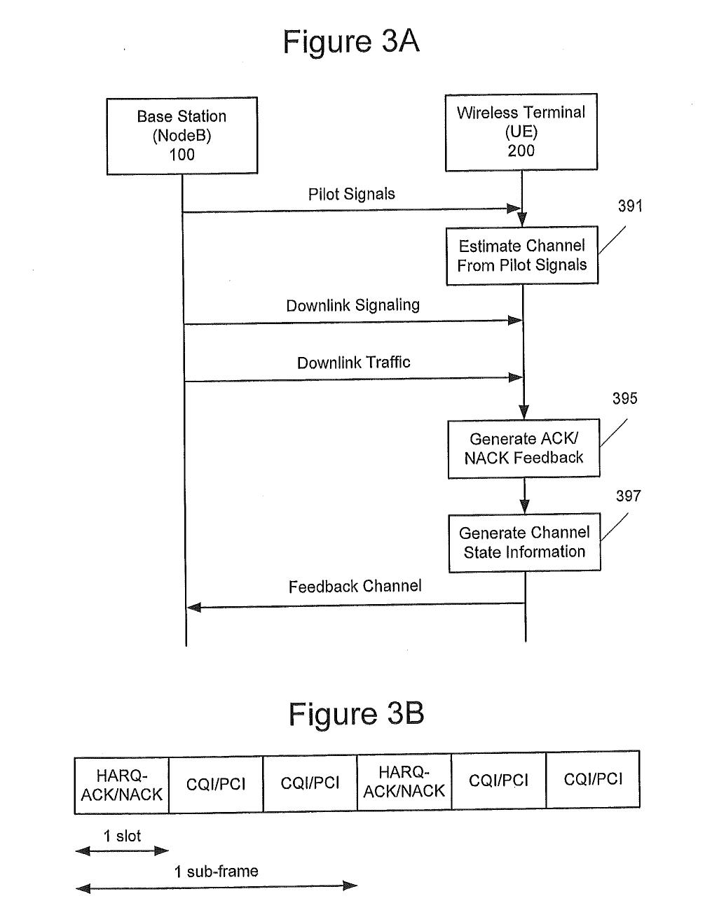

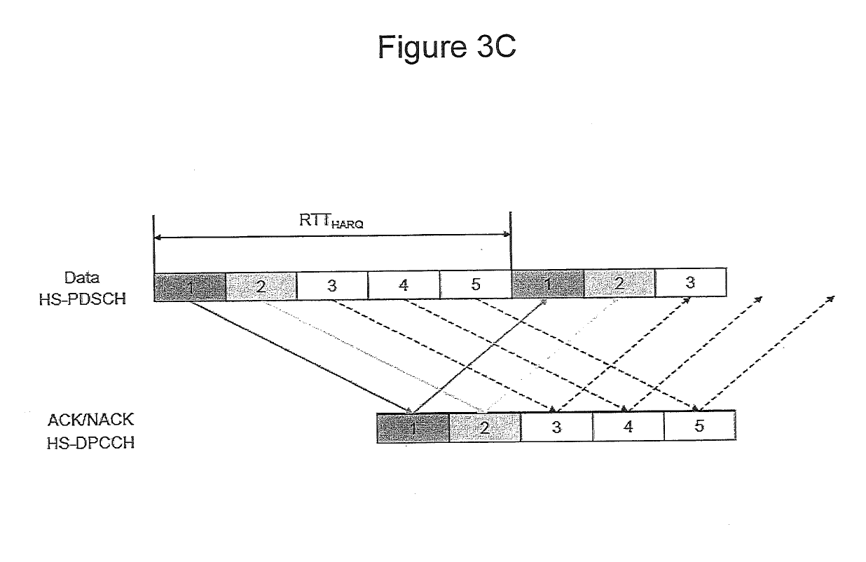

FIG. 3A illustrates a message sequence between base station 100 and wireless terminal 200 in a MIMO communications system. As shown in FIG. 3A, base station 100 transmits pilot signals over the downlink channel(s), and wireless terminal 200 estimates the downlink channel(s) at block 391 (for transmissions from base station 100 to wireless terminal 200) based on the pilot signals. Base station 100 may transmit downlink signaling to identify a rank and precoding vector to be used for subsequent downlink traffic, and downlink traffic may be transmitted by base station 100 in accordance with the downlink signaling. Wireless terminal 200 may then generate ACK/NACK feedback at block 395 (to be provided in a HARQ codeword) and channel state information for the downlink channel at block 397. Wireless terminal 200 may then report the channel state information and the ACK/NACK feedback to base station 100 over a feedback channel. More particularly, the channel state information may include a recommended precoding vector (identified using a precoding index or PCI) and rank (identified using a rank indicator or RI) determined responsive to the channel estimate (based on the pilot signals) and responsive to the ACK/NACK feedback. Stated in other words, wireless terminal 200 may consider the success (or lack thereof) of receiving downlink traffic during a TFRE (as indicated by the ACK/NACK feedback) in the determination of the recommended precoding vector. An example of a format for a feedback channel report for two reporting intervals is illustrated in FIG. 3B, and FIG. 3B shows that the feedback channel report may include a HARQ element/message/codeword (including acknowledge/ACK and/or negative-acknowledge/NACK information) and/or CQI/PCI (channel quality information and/or precoding index) information.

FIG. 3C is a timing diagram illustrating a round trip time RTT_{HARQ} between transmission of a block of downlink data from base station 100 over a downlink data channel (HS-PDSCH) and reception of the corresponding HARQ codeword response (ACK/NACK) from wireless terminal 200 over an uplink control/feedback channel (HS-DPCCH) at base station 100. Each block represents a transmission time interval (TTI) for a TFRE. As shown, a round trip time (RTT_{HARQ}) of 5 transmission time intervals may elapse before a HARQ codeword response corresponding to a given block of downlink data is received, and a delay of 5 transmission time intervals may thus be required before base station 100 can retransmit a block of downlink data responsive to a NACK response. While a five TTI round trip time is discussed/illustrated by way of example, other round trip times may occur according to system configuration, and round trip times within a system may vary, for example, due to varying distances between wireless terminals and base stations, communication traffic conditions, etc. Once base station 100 receives the HARQ ACK/NACK feedback information in a HARQ codeword (e.g., via HS-DPCCH) for a downlink data transport block(s) and channel state information (CSI), a base station scheduler (e.g., an element/functionality of base station processor 101) may determine parameters to schedule/reschedule transport block(s) based on the reported ACK/NACK and CSI.

Wireless terminal 200 may transmit CQI/PCI information (over the uplink control channel HS-DPCCH) including a rank indicator RI (requesting/recommending a MIMO transmission rank) and a precoding index PCI (requesting/recommending a precoding vector) for subsequent downlink transmissions from base station 100 to wireless terminal 200. Base station processor 101 may select the requested/recommended MIMO rank/vector or a different MIMO rank/vector, and base station 100 may identify the selected MIMO rank/vector in downlink signaling transmitted to wireless terminal 200. Base station 100 may then transmit one or more transport data blocks using respective MIMO streams over the downlink channel in a subsequent TFRE in accordance with the selected MIMO rank/vector as downlink traffic. Based on success/failure decoding each received transport data block, wireless terminal 200 may generate respective HARQ ACK/NACK messages (included in a HARQ codeword/codewords) that are transmitted to base station 100 over the feedback channel (e.g., via HS-DPCCH). More particularly, wireless terminal 200 may select the precoding vector (identified using a PCI) and/or rank (identified using a RI) responsive to the ACK/NACK feedback and the channel state information (based on channel state estimates generated using the pilot signals). Still more particularly, if one or more NACKs is/are generated by wireless terminal processor 201 responsive to the downlink traffic, wireless terminal processor 201 may restrict consideration of precoding vectors to a subset of precoding vectors of the precoding codebook to support retransmission of the unsuccessfully received downlink data block or blocks corresponding to the NACK or NACKs. For example, if a NACK is generated, wireless terminal processor 201 may restrict consideration of precoding vectors to those precoding vectors corresponding to ranks that support retransmission of the failed data block or bundled data blocks corresponding to the NACK.

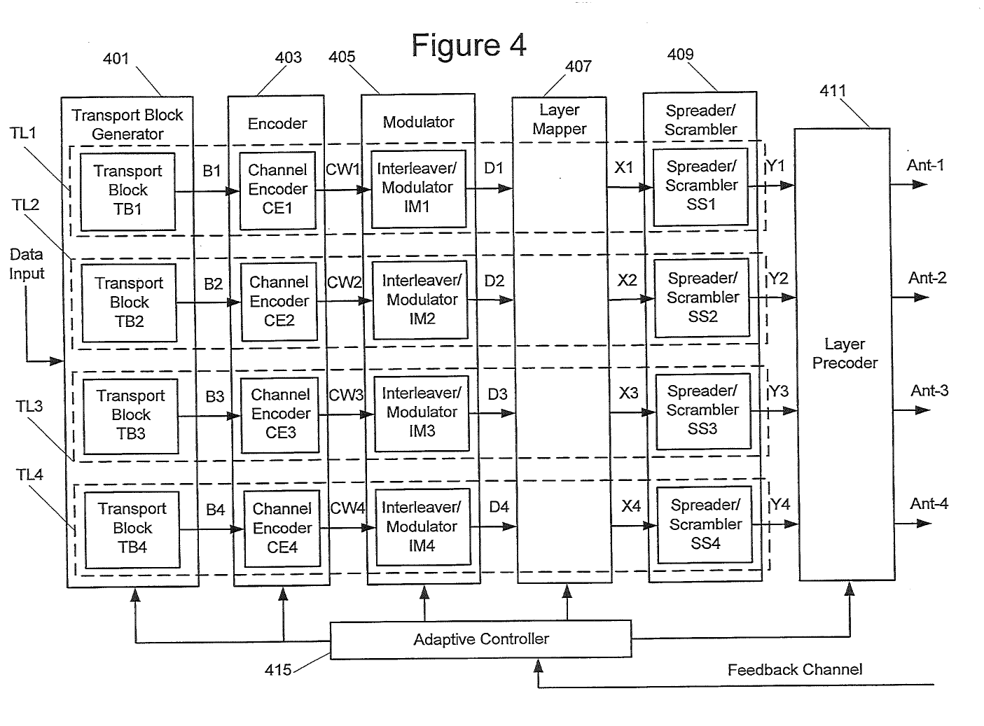

FIG. 4 is block diagram illustrating elements/functionalities of base station processor 101 of FIG. 2 supporting two HARQ process/codeword MIMO with 4 channel encoders and up to four rank MIMO downlink transmission according to some embodiments. According to embodiments of FIG. 4, four channel encoders CE1, CE2, CE3, and CE4 may be provided for four streams of transport data blocks B1, B2, B3, and B4, with symbols of one data input stream for wireless terminal 200 being mapped to as many as four different data streams. As shown, processor 101 may include transport data block generator 401, channel encoder 403, modulator 405, layer mapper 407, spreader/scrambler 409, and layer precoder 411. In embodiments of FIG. 4, channel encoder 403 may include channel encoders CE1, CE2, CE3, and CE4 for the four streams of transport data blocks B1, B2, B3, and B4, modulator 405 may include interleavers/modulators IM1, IM2, IM3, and IM4, and layer mapper 407 may be configured to map resulting symbols of the four streams to as many as four different MIMO layers (streams) X1, X2, X3, and X4 as discussed in greater detail below. Moreover, adaptive controller 415 may be configured to control transport data block generator 401, channel encoder 403, modulator 405, layer mapper 407, and/or layer precoder 411 responsive to channel quality information (CQI) received as feedback from wireless terminal 200. Accordingly, symbols generated responsive to data codewords respectively generated by channel encoders CE1, CE2, CE3, and CE4 using different channel coding (determined by adaptive controller 415 responsive to wireless terminal 200 feedback) may be interleaved and distributed (mapped) to 4 different MIMO layers. More particularly, symbols generated responsive to two data codewords CW (where a data codeword CW is a transport data block with additional channel coding and/or CRC bits) may be interleaved and then split between two different MIMO layers. According to some embodiments discussed herein, layer mapper 407 may perform a one-to-one mapping.

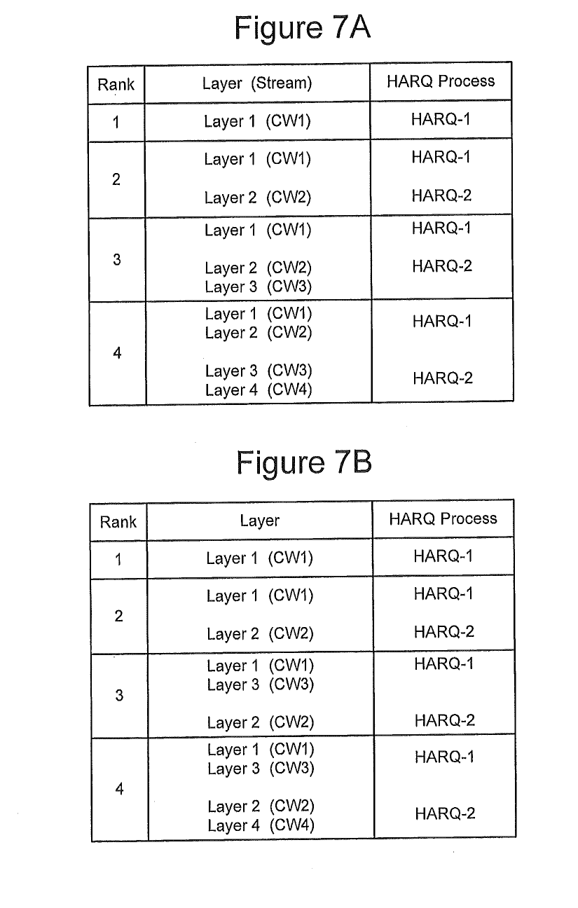

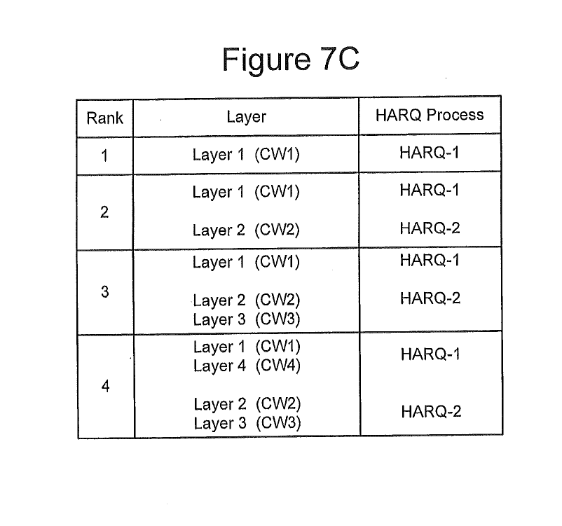

Base station processor 101, for example, may receive input data (e.g., from core network 70, from another base station, etc.) for transmission to wireless terminal 200, and transport data block generator 401 (including transport data block data generators TB1, TB2, TB3, and TB4) may provide a single stream of data blocks (for rank 1 transmissions) or separate the input data into a plurality of different streams of data blocks (for rank 2, rank 3, and rank 4 transmission). FIGS. 7A, 7B, and 7C illustrate mappings of HARQ processes HARQ-1 and HARQ-2 to transmission/reception layers (and respective data codewords CW) according to respective embodiments of present inventive concepts.

For rank 1 transmissions (providing only 1 MIMO layer/stream), all input data may be processed through transport data block generator TB1 to provide a single stream of transport data blocks B1 (including individual transport data blocks b1-1, b1-2, b1-3, etc.) without using transport data block generators TB2, TB3, or TB4 and without generating other layers/streams of transport data blocks B2, B3, or B4. For rank 2 transmissions (providing 2 MIMO layers/streams), transport data block generator TB1 may generate a layer/stream of transport data blocks B1 (including individual transport data blocks b1-1, b1-2, b1-3, etc.), and transport data block generator TB2 may generate a stream of transport data blocks B2 (including individual transport data blocks b2-1, b2-2, b2-3, etc.) without using transport data block generators TB3 or TB4 and without generating other streams of transport data blocks B3 or B4. For rank 3 transmissions (providing 3 MIMO layers/streams), transport data block generator TB1 may generate a stream of transport data blocks B1 (including individual transport data blocks b1-1, b1-2, b1-3, etc.), transport data block generator TB2 may generate a stream of transport data blocks B2 (including individual transport data blocks b2-1, b2-2, b2-3, etc.), and transport data block generator TB3 may generate a stream of transport data blocks B3 (including individual transport data blocks b3-1, b3-2, b3-3, etc.), without using transport data block generator TB4 and without generating another stream of transport data blocks B4. For rank 4 transmissions (providing 4 MIMO layers/streams), transport data block generator TB1 may generate a stream of transport data blocks B1 (including individual transport data blocks b1-1, b1-2, b1-3, etc.), transport data block generator TB2 may generate a stream of transport data blocks B2 (including individual transport data blocks b2-1, b2-2, b2-3, etc.), transport data block generator TB3 may generate a stream of transport data blocks B3 (including individual transport data blocks b3-1, b3-2, b3-3, etc.), and transport data block generator TB4 may generate a stream of transport data blocks B4 (including individual transport data blocks b4-1, b4-2, b4-3, etc.).

Channel encoder 403 (including channel encoders CE1, CE2, CE3, and CE4) may encode the stream/streams of data blocks B1, B2, B3, and/or B4 generated by transport data block generator 401 to provide respective streams of data codewords CW1 (including individual data codewords cw1-1, cw1-2, cw1-3, etc.), data CW2 (including individual data codewords cw1-1, cw2-2, cw2-3, etc.), data CW3 (including individual data codewords cw3-1, cw3-2, cw3-3, etc.), and/or data CW4 (including individual data codewords cw4-1, cw4-2, cw4-3, etc.), for example, using turbo coding, convolutional coding, etc. Moreover, coding characteristics (e.g., coding rates) applied by channel encoders CE1, CE2, CE3, and CE4 may be separately determined by adaptive controller 415 responsive to wireless terminal 200 feedback (e.g., CQI regarding the downlink channel). For rank 1 transmissions, channel encoder 403 may generate a single stream of data codewords CW1 responsive to the stream of data blocks B1 using only channel encoder CE1. For rank 2 transmissions, channel encoder 403 may generate two streams of data codewords CW1 and CW2 responsive to respective streams of data blocks B1 and B2 using channel encoder CE1 and channel encoder CE2. For rank 3 transmissions, channel encoder 403 may generate three streams of data codewords CW1, CW2, and CW3 responsive to respective streams of data blocks B1, B2, and B3 using channel encoder CE1, channel encoder CE2, and channel encoder CE3. For rank 4 transmissions, channel encoder 403 may generate four streams of data codewords CW1, CW2, CW3, and CW4 responsive to respective streams of data blocks B1, B2, B3, and B4 using channel encoder CE1, channel encoder CE2, channel encoder CE3, and channel encoder CE4. According to some embodiments, channel encoders CE1, CE2, CE3, and/or CE4 may apply different coding characteristics (e.g., different coding rates) during rank 2, rank 3, and/or rank 4 transmissions to generate respective (differently coded) data codewords cw1-1, cw2-1, cw3-1, and/or cw4-1 including data to be transmitted during a same TFRE.

Modulator 405 (including interleaver/modulators IM1, IM2, IM3, and IM4) may interleave and modulate the stream/streams of data codewords CW1, CW2, CW3, and/or CW4 generated by channel encoder 403 to provide respective streams of unmapped symbol blocks D1 (including unmapped symbol blocks d1-1, d1-2, d1-3, etc.), D2 (including unmapped symbol blocks d2-1, d2-2, d2-3, etc.), D3 (including unmapped symbol blocks d3-1, d3-2, d3-3, etc.), and/or D4 (including unmapped symbol blocks d4-1, d4-2, d4-3, etc.). For rank 1 transmissions (providing only 1 MIMO layer/stream), modulator 405 may generate a single stream of unmapped symbol blocks D1 responsive to the stream of data codewords CW1 using only interleaver/modulator IM1. For rank 2 transmissions, modulator 405 may generate two streams of unmapped symbol blocks D1 and D2 responsive to respective streams of data codewords CW1 and CW2 using interleaver/modulators IM1 and IM2. For rank 3 transmissions, modulator 405 may generate three streams of unmapped symbol blocks D1, D2, and D3 responsive to respective streams of data codewords CW1, CW2, and CW3 using interleaver/modulators IM1, IM2, and IM3. For rank 4 transmissions, modulator 405 may generate four streams of unmapped symbol blocks D1, D2, D3, and D4 responsive to respective streams of data codewords CW1, CW2, CW3, and CW4 using interleaver/modulators IM1, IM2, IM3, and IM4. Modulator 405 may apply modulation orders responsive to input from adaptive controller 415 determined based on CQI feedback from wireless terminal 200.

In addition, each interleaver/modulator IM1, IM2, IM3, and/or IM4 may interleave data of two or more data codewords of a stream so that two or more consecutive unmapped symbol blocks of a respective stream include symbols representing data of the two or more consecutive data codewords. For example, data of consecutive data codewords cw1-1 and cw1-2 of data codeword stream CW1 may be interleaved and modulated to provide consecutive unmapped symbol blocks d1-1 and d1-2 of stream D1. Similarly, data of consecutive data codewords cw2-1 and cw2-2 of data codeword stream CW2 may be interleaved and modulated to provide consecutive unmapped symbol blocks d2-1 and d2-2 of stream D2; data of consecutive data codewords cw3-1 and cw3-2 of data codeword stream CW3 may be interleaved and modulated to provide consecutive unmapped symbol blocks d3-1 and d3-2 of stream D3; and/or data of consecutive data codewords cw4-1 and cw4-2 of data codeword stream CW4 may be interleaved and modulated to provide consecutive unmapped symbol blocks d4-1 and d4-2 of stream D4.

Symbols of streams of unmapped symbol blocks D1, D2, D3, and D4 may be mapped to respective streams of mapped symbol blocks X1, X2, X3, and X4 (for respective MIMO transmission layers), for example, using a one-to-one mapping. While one-to-one mapping is discussed by way of example, other mappings may be used provided that the mapping function of layer mapper 407 is known to both base station 100 and wireless terminal 200.

Spreader/scrambler 409 may include four spreader/scramblers SS1, SS2, SS3, and SS4, and for each mapped symbol stream provided by layer mapper 407, spreader/scrambler 409 may generate a respective stream of spread symbol blocks Y1, Y2, Y3, and Y4 (e.g., using a Walsh code). Layer precoder 411 may apply a MIMO precoding vector (e.g., by applying precoding weights) of the appropriate rank (based on wireless terminal feedback as interpreted by adaptive controller 415) to the streams of spread symbol blocks for transmission through transceiver 109 and antennas Ant-1, Ant-2, Ant-3, and Ant-4 of antenna array 117. With rank one transmissions, only first layer of transmission elements (e.g., TB1, CE1, IM1, and/or SS1) of FIG. 4 may be used; with rank two transmissions, two layers of transmission elements (e.g., TB1, TB2, CE1, CE2, IM1, IM2, SS1, and/or SS2) of FIG. 4 may be used; with rank three transmissions, three layers of transmission elements (e.g., TB1, TB2, TB3, CE1, CE2, CE3, IM1, IM2, IM3, SS1, SS2, and/or SS3) of FIG. 4 may be used; and with rank four transmissions, four layers of transmission elements (e.g., TB1, TB2, TB3, TB4, CE1, CE2, CE3, CE4, IM1, IM2, IM3, and IM4, SS1, SS2, SS3, and/or SS4) of FIG. 4 may be used.

In embodiments of FIG. 4, base station processor 101 may support two HARQ process MIMO with 4 channel encoders CE1-CE4 generating respective data codewords CW1-CW4. Using feedback from wireless terminal 200 (indicated by “feedback channel”), adaptive controller 415 may choose transport block length, modulation order, and coding rate (used by transport block generator 401, encoder 403, and/or modulator 405). Adaptive controller 415 may also generate precoding weight information used by layer precoder 411. Even though encoder 403 includes four channel encoders CE1-CE4, wireless terminal 200 may only provide feedback information for a maximum of two encoded transport block data codewords. Stated in other words, wireless terminal 200 may provide one HARQ process (HARQ-1) for rank one transmissions (with one transport data blocks per TFRE using one downlink data streams), wireless terminal 200 may provide two HARQ processes (HARQ-1 and HARQ-2) for rank two transmissions (with two transport data blocks per TFRE using two downlink data streams), wireless terminal 200 may provide two HARQ processes (HARQ-1 and HARQ-2) for rank three transmissions (with three transport data blocks per TFRE using three downlink data streams), and wireless terminal 200 may provide two HARQ processes (HARQ-1 and HARQ-2) for rank four transmissions (with four transport data blocks per TFRE using four downlink data streams).

For rank three and rank four transmissions, a number of data streams generated by transport block generator 401, encoder 403, modulator 405, and spreader scrambler 409 is greater than a number of HARQ processes supported by base station 100 and/or wireless terminal 200. According to embodiments of present inventive concepts illustrated in FIG. 7A, a HARQ process may be mapped to more than one data stream for rank 3 and rank 4 transmissions (also referred to as bundling). For rank one transmissions, a first HARQ process (HARQ-1) may be mapped directly to a first data stream/layer (e.g., transmitted using a first transmission layer including TB1, CE1, IM1, and/or SS1 and received using a first reception layer including DM1, SB1, and/or CD1). For rank two transmission, the first HARQ process (HARQ-1) may be mapped directly to a first data stream (e.g., transmitted using a first transmission layer including TB1, CE1, IM1, and/or SS1 and received using a first reception layer including DM1, SB1, and/or CD1), and a second HARQ process (HARQ-2) may be mapped directly to a second data stream (e.g., transmitted using a third transmission layer including TB2, CE2, IM2, and/or SS2 and received using a third reception layer including DM2, SB2, and/or CD2). For rank three transmission, the first HARQ process (HARQ-1) may be mapped to a first data stream (e.g., transmitted using a first transmission layer including TB1, CE1, IM1, and/or SS1 and received using a first reception layer including DM1, SB1, and/or CD1), and the second HARQ process (HARQ-2) may be mapped to a second data stream (e.g., transmitted using a second transmission layer including TB2, CE2, IM2, and/or SS2 and received using a second reception layer including DM2, SB2, and/or CD2) and to a third data stream (e.g., transmitted using a third transmission layer including TB3, CE3, IM3, and/or SS3 and received using a third reception layer including DM3, SB3, and/or CD3). For rank four transmission, the first HARQ process may be mapped to a first data stream (e.g., transmitted using a first transmission layer including TB1, CE1, IM1, and/or SS1 and received using a first reception layer including DM1, SB1, and/or CD1) and to a second data stream (e.g., transmitted using a second transmission layer including TB2, CE2, IM2, and/or SS2 and received using a second reception layer including DM2, SB2, and/or CD2), and the second HARQ process may be mapped to a third data stream (e.g., transmitted using a third transmission layer including TB3, CE3, IM3, and/or SS3 and received using a third reception layer including DM3, SB3, and/or CD3) and to a fourth data stream (e.g., transmitted using a fourth transmission layer including TB4, CE4, IM4, and/or SS4 and received using a fourth reception layer including DM4, SB4, and/or CD4).

According to embodiments of present inventive concepts illustrated in FIG. 7B, mappings of HARQ processes for ranks 1 and 2 may be the same as that discussed above with respect to FIG. 7A, but mappings of ranks 3 and 4 may be modified to maintain a mapping of first transmission/reception layer to the first HARQ process (HARQ-1) for all ranks, to maintain a mapping of second transmission/reception layer to the second HARQ process (HARQ-2) for ranks 2, 3, and 4, and to maintain a mapping of third transmission/reception layer to the first HARQ process (HARQ-1) for ranks 3 and 4. For rank three transmission according to embodiments of FIG. 7B, the first HARQ process (HARQ-1) may be mapped to a first data stream (e.g., transmitted using a first transmission layer including TB1, CE1, IM1, and/or SS1 and received using a first reception layer including DM1, SB1, and/or CD1) and to a third data stream (e.g., transmitted using a third transmission layer including TB3, CE3, IM3, and/or SS3 and received using a third reception layer including DM3, SB3, and/or CD3), and the second HARQ process (HARQ-2) may be mapped to a second data stream (e.g., transmitted using a second transmission layer including TB2, CE2, IM2, and/or SS2 and received using a second reception layer including DM2, SB2, and/or CD2). For rank four transmission, the first HARQ process may be mapped to a first data stream (e.g., transmitted using a first transmission layer including TB1, CE1, IM1, and/or SS1 and received using a first reception layer including DM1, SB1, and/or CD1) and to a third data stream (e.g., transmitted using a third transmission layer including TB3, CE3, IM3, and/or SS3 and received using a third reception layer including DM3, SB3, and/or CD3), and the second HARQ process may be mapped a second data stream (e.g., transmitted using a second transmission layer including TB2, CE2, IM2, and/or SS2 and received using a second reception layer including DM2, SB2, and/or CD2) and to a fourth data stream (e.g., transmitted using a fourth transmission layer including TB4, CE4, IM4, and/or SS4 and received using a fourth reception layer including DM4, SB4, and/or CD4).

According to embodiments of FIG. 7B: a mapping of layer 1 to the first HARQ process HARQ-1 remains the same for ranks 1, 2, 3, and 4; a mapping of layer 2 to the second HARQ process HARQ-2 remains the same for ranks 2, 3, and 4; and a mapping of layer 3 to the first HARQ process HARQ-1 remains the same for ranks 3 and 4. Accordingly, if the rank changes between ranks 3 and 4, the bundled mapping of layers 1 and 3 to the first HARQ process HARQ-1 stays the same. Similarly, if the rank changes between ranks 2 and 3, the direct mapping of layer 2 to the second HARQ process HARQ-2 stays the same. Moreover, if the rank changes between ranks 1 and 2, the direct mapping of layer 1 to the first HARQ process HARQ-1 stays the same. Partial retransmission (e.g., where previously transmitted data for one HARQ process is retransmitted and new data for the other HARQ process is initially transmitted during the same TTI) may thus be supported while changing rank as long as the layer or layers mapped to the HARQ process for the retransmission is unchanged.

According to embodiments of present inventive concepts illustrated in FIG. 7C, mappings of HARQ processes for ranks 1 and 2 may be the same as that discussed above with respect to FIGS. 7A and 7B, but mappings of ranks 3 and 4 may be modified to maintain a mapping of first transmission/reception layer to the first HARQ process (HARQ-1) for all ranks, to maintain a mapping of second transmission/reception layer to the second HARQ process (HARQ-2) for ranks 2, 3, and 4, and to maintain a mapping of third transmission/reception layer to the second HARQ process (HARQ-2) for ranks 3 and 4. For rank three transmission according to embodiments of FIG. 7C, the first HARQ process (HARQ-1) may be mapped to a first data stream (e.g., transmitted using a first transmission layer including TB1, CE1, IM1, and/or SS1 and received using a first reception layer including DM1, SB1, and/or CD1), and the second HARQ process (HARQ-2) may be mapped to a second data stream (e.g., transmitted using a second transmission layer including TB2, CE2, IM2, and/or SS2 and received using a second reception layer including DM2, SB2, and/or CD2) and to a third data stream (e.g., transmitted using a third transmission layer including TB3, CE3, IM3, and/or SS3 and received using a third reception layer including DM3, SB3, and/or CD3). For rank four transmission, the first HARQ process may be mapped to a first data stream (e.g., transmitted using a first transmission layer including TB1, CE1, IM1, and/or SS1 and received using a first reception layer including DM1, SB1, and/or CD1) and to a fourth data stream (e.g., transmitted using a fourth transmission layer including TB4, CE4, IM4, and/or SS4 and received using a fourth reception layer including DM4, SB4, and/or CD4), and the second HARQ process may be mapped a second data stream (e.g., transmitted using a second transmission layer including TB2, CE2, IM2, and/or SS2 and received using a second reception layer including DM2, SB2, and/or CD2) and to a third data stream (e.g., transmitted using a third transmission layer including TB3, CE3, IM3, and/or SS3 and received using a third reception layer including DM3, SB3, and/or CD3).

According to embodiments of FIG. 7C: a mapping of layer 1 to the first HARQ process HARQ-1 remains the same for ranks 1, 2, 3, and 4; a mapping of layer 2 to the second HARQ process HARQ-2 remains the same for ranks 2, 3, and 4; and a mapping of layer 3 to the second HARQ process HARQ-2 remains the same for ranks 3 and 4. Accordingly, if the rank changes between ranks 3 and 4, the bundled mapping of layers 2 and 3 to the second HARQ process HARQ-2 stays the same. Similarly, if the rank changes between ranks 1 and 2, between ranks 2 and 3, or between ranks 1 and 3, the direct mapping of layer 1 to the first HARQ process HARQ-1 stays the same. Partial retransmission (e.g., where previously transmitted data for one HARQ process is retransmitted and new data for the other HARQ process is initially transmitted during the same TTI) may thus be supported while changing rank as long as the layer or layers mapped to the HARQ process for the retransmission is unchanged.

Based on the rank chosen by adaptive controller 415, transport data blocks may be passed to encoder 403, and encoder outputs may be interleaved and modulated using modulator 405. Outputs of modulator 405 may be mapped to space time layers using layer mapper 407, and as discussed above, layer mapper 407 may provide a one-to-one layer mapping. The symbol stream(s) generated by layer mapper 407 may be spread and scrambled using spreader/scrambler 409, and layer precoder 411 may precode outputs of spreader/scrambler 409, with precoder outputs being passed through transceiver 109 and antenna array 117 (including Antennas Ant-1, Ant-2, Ant-3, and Ant-4).

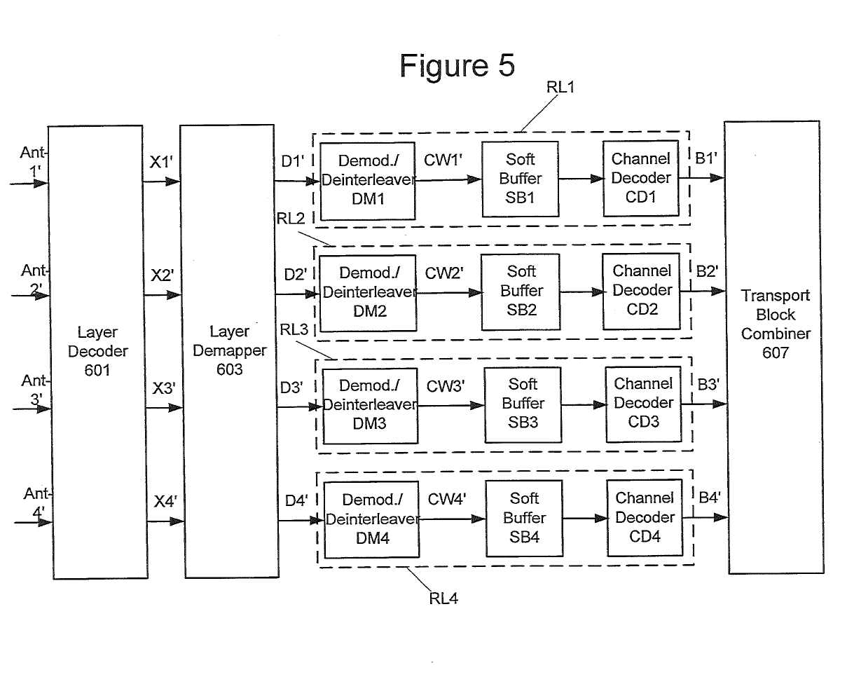

At wireless terminal 200, operations of processor 201 may mirror operations of base station processor 101 when receiving the MIMO downlink communications transmitted by the base station. More particularly, elements/functionalities of wireless terminal processor 201 are illustrated in FIG. 5 mirroring elements/functionalities of base station processor 101 discussed above with reference to FIG. 4.

Radio signals may be received through MIMO antenna elements of MIMO antenna array 217 and transceiver 209, and the radio signals may be decoded by layer decoder 601 using a MIMO decoding vector to generate a plurality of MIMO decoded symbol layers X1′, X2′, X3′, and/or X4′ depending on MIMO rank used for transmission/reception. Layer Decoder 601 may use a decoding vector corresponding to the precoding vector used by base station 100. Layer decoder 601 may generate a single decoded symbol layer X1′ for rank 1 reception, layer decoder 601 may generate two decoded symbol layers X1′ and X2′ for rank 2 reception, layer decoder 601 may generate three decoded symbol layers X1′, X2′, and X3′ for rank 3 reception, and layer decoder 601 may generate four decoded symbol layers X1′, X2′, X3′, and X4′ for rank 4 transmission. Layer decoder 601 may thus perform a converse of operations performed by layer precoder 411 and spreader/scrambler 409 of base station 100. Layer decoder 601 may perform functionalities of a MIMO detector (corresponding to a converse of layer precoder 411) and of dispreading/descrambling blocks for each data stream/layer (corresponding to a converse of spreader/scrambler 409). Layer demapper 603 may function as a converse of layer mapper 407 to demap decoded symbol layers X1′, X2′, X3′, and/or X4′ to respective unmapped symbol layers D1′, D2′, D3′, and/or D4′ according to the transmission rank.

For rank one reception, layer demapper 603 may demap symbols of decoded symbol layer X1′ blocks x1′-j directly to symbols of unmapped symbol layer D1′ blocks d1′-j, demodulator/deinterleaver DM-1 may demodulate/deinterleave unmapped symbol layer blocks d1′-j to provide data codewords cw1′-j of data codeword stream CW1′, and channel decoder CD1 may decode data codewords cw1′-j of data codeword stream CW1′ to provide transport blocks b1′-j of stream B1′. Transport block generator 607 may then pass transport blocks b1′-j of stream B1′ as a data stream. During rank one reception, demodulators/deinterleavers DM2, DM3, and DM4 and channel decoders CD2, CD3, and CD4 may be unused.

For rank two reception, layer decoder 601 may generate decoded symbol layers X1′ and X2′. Layer demapper 603 may demap symbols of decoded symbol layer X1′ blocks x1′-j directly to symbols of unmapped symbol layer D1′ blocks d1′-j, and layer demapper 603 may demap symbols of decoded symbol layer X2′ blocks x2′-j directly to symbols of unmapped symbol layer D2′ blocks d2′-j. Demodulator/deinterleaver DM-1 may demodulate/deinterleave unmapped symbol layer blocks d1′-j to provide data codewords cw1′-j of data codeword stream CW1′, and demodulator/deinterleaver DM-2 may demodulate/deinterleave unmapped symbol layer blocks d2′-j to provide data codewords cw2′-j of data codeword stream CW2′. Channel decoder CD1 may decode data codewords cw1′-j of data codeword stream CW1′ to provide transport blocks b1′-j of stream B1′, and channel decoder CD2 may decode data codewords cw2′-j of data codeword stream CW2′ to provide transport blocks b2′-j of stream B2′. Transport block generator 607 may then combine transport blocks b1′-j and b2′-j of streams B1′ and B2′ as a data stream. During rank two reception, demodulators/deinterleavers DM3 and DM4 and channel decoders CD3 and CD4 may be unused.

For rank three reception, layer decoder 601 may generate decoded symbol layers X1′, X2′, and X3′. Layer demapper 603 may demap symbols of decoded symbol layer X1′ blocks x1′-j directly to symbols of unmapped symbol layer D1′ blocks d1′-j, layer demapper 603 may demap symbols of decoded symbol layer X2′ blocks x2′-j directly to symbols of unmapped symbol layer D2′ blocks d2′-j, and layer demapper 603 may demap symbols of decoded symbol layer X3′ blocks x3′-j directly to symbols of unmapped symbol layer D3′ blocks d3′-j. Demodulator/deinterleaver DM-1 may demodulate/deinterleave unmapped symbol layer blocks d1′-j to provide data codewords cw1′-j of data codeword stream CW1′, demodulator/deinterleaver DM-2 may demodulate/deinterleave unmapped symbol layer blocks d2′-j to provide data codewords cw2′-j of data codeword stream CW2′, and demodulator/deinterleaver DM-3 may demodulate/deinterleave unmapped symbol layer blocks d3′-j to provide data codewords cw3′-j of data codeword stream CW3′. Channel decoder CD1 may decode data codewords cw1′-j of data codeword stream CW1′ to provide transport blocks b1′-j of stream B1′, channel decoder CD2 may decode data codewords cw2′-j of data codeword stream CW2′ to provide transport blocks b2′-j of stream B2′, and channel decoder CD3 may decode data codewords cw3′-j of data codeword stream CW3′ to provide transport blocks b3′-j of stream B3′. Transport block generator 607 may then combine transport blocks b1′-j, b2′-j, and b3′-j of streams B1′, B2′, and B3′ as a data stream. During rank three reception, demodulator/deinterleaver DM4 and channel decoder CD4 may be unused.

For rank four reception, layer decoder 601 may generate decoded symbol layers X1′, X2′, X3′, X4′. Layer demapper 603 may demap symbols of decoded symbol layer X1′ blocks x1′-j directly to symbols of unmapped symbol layer D1′ blocks d1′ j, layer demapper 603 may demap symbols of decoded symbol layer X2′ blocks x2′-j directly to symbols of unmapped symbol layer D2′ blocks d2′-j, and layer demapper 603 may demap symbols of decoded symbol layer X3′ blocks x3′-j directly to symbols of unmapped symbol layer D3′ blocks d3′-j, and layer demapper 603 may demap symbols of decoded symbol layer X4′ blocks x4′-j directly to symbols of unmapped symbol layer D4′ blocks d4′-j. Demodulator/deinterleaver DM-1 may demodulate/deinterleave unmapped symbol layer blocks d1′-j to provide data codewords cw1′-j of data codeword stream CW1′, demodulator/deinterleaver DM-2 may demodulate/deinterleave unmapped symbol layer blocks d2′-j to provide data codewords cw2′-j of data codeword stream CW2′, demodulator/deinterleaver DM-3 may demodulate/deinterleave unmapped symbol layer blocks d3′-j to provide data codewords cw3′-j of data codeword stream CW3′, and demodulator/deinterleaver DM-4 may demodulate/deinterleave unmapped symbol layer blocks d4′-j to provide data codewords cw4′-j of data codeword stream CW4′. Channel decoder CD1 may decode data codewords cw1′-j of data codeword stream CW1′ to provide transport blocks b1′-j of stream B1′, channel decoder CD2 may decode data codewords cw2′-j of data codeword stream CW2′ to provide transport blocks b2′-j of stream B2′, channel decoder CD3 may decode data codewords cw3′-j of data codeword stream CW3′ to provide transport blocks b3′-j of stream B3′, and channel decoder CD4 may decode data codewords cw4′-j of data codeword stream CW4′ to provide transport blocks b4′-j of stream B4′. Transport block generator 607 may then combine transport blocks b1′-j, b2′ j, b3′-j, and b4′-j of streams B1′, B2′, B3′, and B4′ as a data stream.

As further shown in FIG. 5, a respective soft buffer SB1, SB2, SB3, and SB4 may be provided for each stream of received data, and each decoder CD1, CD2, CD3, and CD4 may be configured to determine whether each decoded transport data block passes or fails decoding. In greater detail, each undecoded transport data block generated by a demodulator/decoder DM may be saved in the respective soft buffer SB until a decoding result is determined by the channel decoder CD. If the transport data block passes decoding, an ACK (acknowledge message) may be generated and provided as feedback for the base station, and retransmission of the successfully decoded (passed) data block is not required. If the transport data block does not pass decoding, a NACK (negative acknowledge message) may be generated and provided as feedback for the base station, and the undecoded output of the demodulator/deinterleaver (also referred to as soft bits) may be saved in soft buffer SB. Responsive to the NACK, the base station may retransmit the failed transport data block, and wireless terminal 200 may use the retransmitted data block together with the previously undecoded output of the demodulator/deinterleaver (that is saved in the respective soft buffer) to decode the retransmitted data block on the second pass. By using the soft buffer to combine first and second versions of the demodulated data block, a likelihood of successful decoding may be increased after retransmission.

As shown in FIG. 5, layer decoder 601 (e.g., including a MIMO detector such as a minimum mean squared error or MMSE receiver), may reduce interference from the multipath channel and/or may reduce other antenna interference. After dispreading, demapping, demodulating, and/or deinterleaving, wireless terminal 200 may attempt to decode the coded bits of a transport data block using a respective channel decoder. If the decoding attempt fails, wireless terminal 200 buffers the received soft bits of the transport data block in the respective soft buffer, and requests retransmission of the transport data block by transmitting a NACK message (e.g., as a part of an HARQ-ACK codeword). Once the retransmission is received (and subjected to decoding, demapping, demodulating, and/or deinterleaving) by wireless terminal 200, wireless terminal may combine the buffered soft bits with the received soft bits from the retransmission and attempt to decode the combination using a respective channel decoder.

For soft combining to operate properly, the wireless terminal may need to know whether a received transmission is a new transmission of a transport data block or a retransmission of a previously transmitted transport data block. For this purpose, the downlink control signaling may include a data indicator (also referred to as an indicator, a new data indicator, a new/old data indicator, etc.) that is used by the wireless terminal to control whether the soft buffer should be cleared or whether soft combining of the soft buffer and the received soft bits should take place. For a given transmission/retransmission to wireless terminal 200, the data indicator may thus have one value to indicate an initial transmission of new data and another value to indicate a retransmission of previously transmitted data.

Whenever a current transmission is not a retransmission, a NodeB base station MAC-ehs element of base station processor 101 may increment a single bit data indicator. Accordingly, the single bit data indicator may be toggled each time a new transport data block is transmitted over a MIMO layer. The data indicator can thus be used by wireless terminal processor 201 to clear the soft buffer/buffers for each initial transmission because no soft combining should be done for new/initial transmissions. The indicator may also be used to detect error cases in the status signaling. If the data indicator is not toggled despite the fact that the previous data for the HARQ process in question was correctly decoded and acknowledged (using an ACK message), for example, an error in the uplink signaling has most likely occurred. Similarly, if the indicator is toggled but the previous data for the HARQ process was not correctly decoded, the wireless terminal may replace the data previously in the soft buffer for the HARQ process with the new received data.

For rank four transmissions, wireless terminal 200 may thus receive up to four transport data blocks in a same TFRE to support four streams of transport data blocks. After decoding four data blocks for a TFRE during a rank 4 transmission, each decoder CD1, CD2, CD3, and CD4 may generate a respective local ACK or NACK depending on whether the respective transport data block passed or failed decoding. In a rank 4 transmission according to embodiments of FIG. 7A, decoders CD1 and CD2 (and corresponding soft buffers SB1 and SB2) may be mapped to the first HARQ process (HARQ-1) so that the resulting HARQ ACK/NACK is an ACK only if both decoders CD1 and CD2 generate a local ACK and the resulting HARQ AKC/NACK message from the first HARQ process is a NACK if either decoder CD1 or CD2 generated a local NACK; and decoders CD3 and CD4 (and corresponding soft buffers SB3 and SB4) may be mapped to the second HARQ process (HARQ-2) so that the resulting HARQ ACK/NACK from the second HARQ process is an ACK only if both decoders CD3 and CD4 generate a local ACK and the resulting HARQ AKC/NACK message is a NACK if either decoder CD3 or CD4 generated a local NACK. In a rank 4 transmission according to embodiments of FIG. 7B, decoders CD1 and CD3 (and corresponding soft buffers SB1 and SB3) may be mapped to the first HARQ process (HARQ-1) so that the resulting HARQ ACK/NACK is an ACK only if both decoders CD1 and CD3 generate a local ACK and the resulting HARQ AKC/NACK message from the first HARQ process is a NACK if either decoder CD1 or CD3 generated a local NACK; and decoders CD2 and CD4 (and corresponding soft buffers SB2 and SB4) may be mapped to the second HARQ process (HARQ-2) so that the resulting HARQ ACK/NACK from the second HARQ process is an ACK only if both decoders CD2 and CD4 generate a local ACK and the resulting HARQ AKC/NACK message is a NACK if either decoder CD2 or CD4 generates a local NACK. In a rank 4 transmission according to embodiments of FIG. 7C, decoders CD1 and CD4 (and corresponding soft buffers SB1 and SB4) may be mapped to the first HARQ process (HARQ-1) so that the resulting HARQ ACK/NACK is an ACK only if both decoders CD1 and CD4 generate a local ACK and the resulting HARQ AKC/NACK message from the first HARQ process is a NACK if either decoder CD1 or CD4 generated a local NACK; and decoders CD2 and CD3 (and corresponding soft buffers SB2 and SB3) may be mapped to the second HARQ process (HARQ-2) so that the resulting HARQ ACK/NACK from the second HARQ process is an ACK only if both decoders CD2 and CD3 generate a local ACK and the resulting HARQ AKC/NACK message is a NACK if either decoder CD2 or CD3 generates a local NACK.

For rank three transmissions, wireless terminal 200 may thus receive up to three transport data blocks in a same TFRE. After decoding three data blocks for a TFRE during a rank 3 transmission, each decoder CD1, CD2, and CD3 may generate a respective local ACK or NACK depending on whether the respective transport data block passed or failed decoding. In a rank 3 transmission according to embodiments of FIGS. 7A and 7C, decoder CD1 (and corresponding soft buffer SB1) may be mapped to the first HARQ process (HARQ-1) so that the resulting HARQ ACK/NACK from the first HARQ process is an ACK if decoder CD1 generates a local ACK and the resulting HARQ AKC/NACK message is a NACK if decoder CD1 generates a local NACK, and decoders CD2 and CD3 (and corresponding soft buffers SB2 and SB3) may be mapped to the second HARQ process (HARQ-2) so that the resulting HARQ ACK/NACK is an ACK only if both decoders CD2 and CD3 generate a local ACK and the resulting HARQ AKC/NACK message from the second HARQ process is a NACK if either decoder CD2 or CD3 generated a local NACK. In a rank 3 transmission according to embodiments of FIG. 7B, decoders CD1 and CD3 (and corresponding soft buffers SB1 and SB3) may be mapped to the first HARQ process (HARQ-1) so that the resulting HARQ ACK/NACK is an ACK only if both decoders CD1 and CD3 generate a local ACK and the resulting HARQ AKC/NACK message from the first HARQ process is a NACK if either decoder CD1 or CD3 generates a local NACK, and decoder CD2 (and corresponding soft buffer SB2) may be mapped to the second HARQ process (HARQ-2) so that the resulting HARQ ACK/NACK from the second HARQ process is a local ACK if decoder CD2 generates an ACK and the resulting HARQ AKC NACK message is a NACK if decoder CD2 generates a local NACK.

For rank two transmissions, wireless terminal 200 may receive up to two transport data blocks in a same TFRE. After decoding two data blocks for a TFRE during a rank 2 transmission, each decoder CD1 and CD2 may generate a respective local ACK or NACK depending on whether the respective transport data block passed or failed decoding. In a rank two transmission according to embodiments of all of FIGS. 7A, 7B, and 7C, decoder CD1 (and corresponding soft buffer SB1) may be mapped to the first HARQ process (HARQ-1) so that the resulting HARQ ACK/NACK is an ACK only if decoder CD1 generates a local ACK and the resulting HARQ AKC/NACK message from the first HARQ process is a NACK if decoder CD1 generates a local NACK; and decoder CD2 (and corresponding soft buffer SB2) may be mapped to the second HARQ process (HARQ-2) so that the resulting HARQ ACK/NACK from the second HARQ process is an ACK if decoder CD2 generates a local ACK and the resulting HARQ AKC/NACK message is a NACK if decoder CD2 generates a local NACK.

For rank one transmissions, wireless terminal 200 may receive one transport data block in a TFRE. After decoding one data block for a TFRE during a rank 1 transmission, decoder CD1 may generate a respective ACK or NACK depending on whether the transport data block passed or failed decoding. In a rank one transmission according to embodiments of all of FIGS. 7A, 7B, and 7C, decoder CD1 (and corresponding soft buffer SB1) may be mapped to the first HARQ process (HARQ-1) so that the resulting HARQ ACK/NACK is an ACK if decoder CD1 generates an ACK and the resulting HARQ AKC/NACK message from the first HARQ process is a NACK if decoder CD1 generates a NACK.

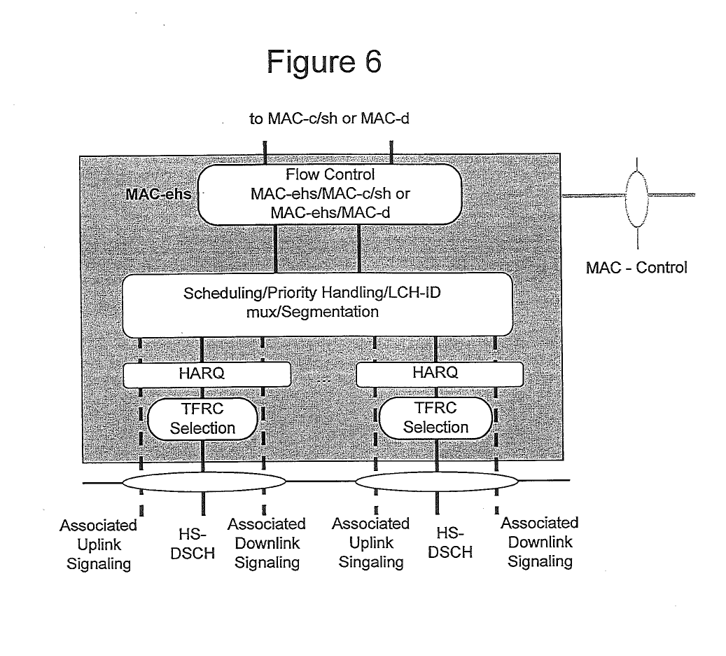

According to embodiments of present inventive concepts, a HARQ process in a MAC-ehs of wireless terminal processor 101 may provide MAC functionality illustrated in FIG. 6. FIG. 6 illustrates MAC (Media Access Control) functionality at wireless terminal 200. As shown in FIG. 6, one HARQ entity may handle HARQ functionality for one user per HS-DSCH (High Speed Downlink Shared Channel). One HARQ entity may be capable of supporting multiple instances (multiple HARQ processes) of stop and wait HARQ protocols. According to some embodiments, there may be one HARQ entity per HS-DSCH, one HARQ process per TTI (Transmission Time Interval) for single layer/stream (rank one) transmission/reception, and two HARQ processes per TTI for two layer/stream (rank two) transmission/reception, three layer/stream (rank three) transmission/reception, and four layer/stream (rank four) transmission/reception.

Because only 2 HARQ processes are supported for three downlink layer/streams (rank three) MIMO transmission/reception and for four downlink layers/stream (rank four) MIMO transmission/reception according to some embodiments of present inventive concepts, the mapping of soft buffers may be provided according to FIG. 7A, FIG. 7B, or FIG. 7C for rank 3 and rank 4 downlink transmissions. Whenever the data indicator for a shared HARQ process (i.e., a HARQ process shared by two or more streams/layers) indicates that new data has been initially transmitted over the downlink (e.g., the new data indicator bit has been toggled), the soft buffers for both/all layers/streams associated with the shared HARQ process should/may be cleared. Whenever the data indicator for a shared HARQ process (i.e., a HARQ process shared by two or more streams/layers) indicates that old data is being retransmitted, the soft buffers for both/all layers/streams associated with the shared HARQ process should/may be combined with the retransmitted data of the respective data streams.

For rank one transmissions, a first HARQ process may be used for the single downlink data stream (e.g., for a downlink stream transmitted using TB1, CE1, IM1, and/or SS1 defining a first transmission layer and received using DM1, SB1, and/or CD1 defining a first reception layer) according to embodiments of FIGS. 7A, 7B, and 7C. Accordingly, one data indicator flag may be transmitted by base station 100 for one transport data block of the downlink data stream, and wireless terminal 200 may receive the one transport data block using DM1, SB1, and CD1. If the data indicator indicates that the transport data block is a new/initial transmission, wireless terminal 200 may clear soft buffer SB 1 and attempt to decode using channel decoder CD1. If the data indicator indicates that the transport data block is a retransmission of a previously failed transmission, wireless terminal 200 may combine soft bits of the retransmission (generated by demodulator/deinterleaver DM1) with soft bits from soft buffer SB 1 and may attempt to decode the combination using channel decoder CD1. If channel decoder CD1 is able to successfully decode the transmission/retransmission, an ACK message is generated and transmitted to base station 100 (e.g., as an element of a HARQ-ACK codeword, also referred to as a HARQ codeword). If channel decoder CD1 is unable to decode the transmission/retransmission, a NACK message is generated and transmitted to base station 100 (e.g., as an element of a HARQ-ACK codeword, also referred to as a HARQ codeword). A single HARQ process (e.g., HARQ-1 including a data indicator, a NACK message and/or an ACK message) may thus map to each transport data block transmitted over the rank/layer one downlink data stream.

For rank two transmissions according to embodiments of FIGS. 7A, 7B, and 7C, a first HARQ process (e.g., HARQ-1 including a data indicator, a NACK message and/or an ACK message) may map to each transport data block transmitted over a first stream of the rank two transmission (e.g., for a downlink stream transmitted using TB1, CE1, IM1, and/or SS1 defining a first transmission layer and received using DM1, SB1, and/or CD1 defining a first reception layer), and a second HARQ process (e.g., HARQ-2 including a data indicator, a NACK message and/or an ACK message) may map to each transport data block transmitted over a second stream of the rank two transmission (e.g., for a downlink stream transmitted using TB2, CE2, IM2, and/or SS2 defining a second transmission layer and received using DM2, SB2, and/or CD2 defining a second reception layer). Each of the first and second HARQ processes-(HARQ-1 and HARQ-2) may thus operate for transport data blocks of respective streams of the rank two transmissions as discussed above with respect to rank/layer one transmissions. Stated in other words, a respective data indicator may be provided for each transport data block received during a same TFRE, soft buffers for the respective downlink data streams may be independently cleared or maintained for retransmission combining responsive to the respective data indicators, and respective ACK/NACK messages may be generated and transmitted to base station 100 for each transport data block received during a same TFRE.

For higher order transmission ranks/layers, however, a HARQ process may be shared by two or more downlink data streams to reduce uplink feedback signaling. For rank three downlink transmissions, one HARQ process (including one data indicator and one ACK/NACK message per TFRE) may map to a one stream of transport data blocks, and another HARQ process (including one data indicator and one ACK/NACK message per TFRE) may map to two streams of transport data blocks. For rank three downlink transmissions according to embodiments of FIGS. 7A and 7C, for example, a first HARQ process (HARQ-1) may map to each transport data block transmitted over a first stream of the rank three transmission (e.g., for a downlink stream transmitted using TB1, CE1, IM1, and/or SS1 defining a first transmission layer and received using DM1, SB1, and/or CD1 defining a first reception layer), and a second HARQ process (HARQ-2) may map to each transport data block transmitted over a second stream of the rank three transmission (e.g., for a downlink stream transmitted using TB2, CE2, IM2, and/or SS2 defining a second transmission layer and received using DM2, SB2, and/or CD2 defining a second reception layer) and to each transport data block transmitted over a third stream of the rank three transmission (e.g., for a downlink stream transmitted using TB3, CE3, IM3, and/or SS3 defining a third transmission layer and received using DM3, SB3, and/or CD3 defining a third reception layer). During rank three transmissions according to embodiments of FIGS. 7A and 7C, the second HARQ process may thus be shared by data blocks of the second and third streams that are transmitted using a same TFRE so that the second and third streams are bundled to a same HARQ process. Accordingly, one HARQ ACK/NACK message and one data indicator may be mapped to both data blocks of a same TFRE for the second and third streams during rank three transmission. In contrast, the first HARQ process, may be applied to only the first data stream, so that one HARQ ANK/NACK message and one data indicator may be mapped to one data block of each TFRE of the first stream.

For rank three downlink transmissions according to embodiments of FIG. 7B, a first HARQ process (HARQ-1) may map to each transport data block transmitted over a first stream of the rank three transmission (e.g., for a downlink stream transmitted using TB1, CE1, IM1, and/or SS1 defining a first transmission layer and received using DM1, SB1, and/or CD1 defining a first reception layer) and to each transport data block transmitted over a third stream of the rank three transmission (e.g., for a downlink stream transmitted using TB3, CE3, IM3, and/or SS3 defining a third transmission layer and received using DM3, SB3, and/or CD3 defining a third reception layer), and a second HARQ process (HARQ-2) may map to each transport data block transmitted over a second stream of the rank three transmission (e.g., for a downlink stream transmitted using TB2, CE2, IM2, and/or SS2 defining a second transmission layer and received using DM2, SB2, and/or CD2 defining a second reception layer). During rank three transmissions according to embodiments of FIG. 7B, the first HARQ process may thus be shared by data blocks of the first and third streams that are transmitted using a same TFRE so that the first and third streams are bundled to a same HARQ process. Accordingly, one HARQ ACK/NACK message and one data indicator may be mapped to both data blocks of a same TFRE for the first and third streams during rank three transmission. In contrast, the second HARQ process may be applied to only the second data stream, so that one HARQ ACK/NACK message and one data indicator may be mapped to one data block of each TFRE of the second stream.

According to embodiments of FIGS. 7A and 7C, first, second, and third transport data blocks may be transmitted during a same TFRE over respective the first, second, and third streams during a rank three transmission. A data indicator may be transmitted by base station 100 for both of the second and third transport data blocks of the second and third downlink data streams. If the data indicator indicates a new/initial transmission, wireless terminal 200 may clear soft buffers SB2 and SB3 and attempt to decode the second and third transport data blocks using channel decoders CD2 and CD3. If the first data indicator indicates a retransmission, wireless terminal 200 may combine soft bits of the second and third transport data blocks (generated by demodulators/deinterleavers DM2 and DM3) with soft bits from respective soft buffers SB2 and SB3 and attempt to decode the combinations using respective channel decoders CD2 and CD3. If both channel decoders CD2 and CD3 are able to successfully decode the transmissions/retransmissions, an ACK message is generated and transmitted to base station 100 (e.g., as an element of a shared HARQ-ACK codeword). If either of channel decoders CD2 or CD3 is unable to decode the transmissions/retransmissions, a NACK message is generated and transmitted to base station 100 (e.g., as an element of a shared HARQ-ACK codeword). The second HARQ process (e.g., HARQ-2 including a single data indicator and a single ACK/NACK message) may thus be shared by two transport data blocks transmitted over different downlink data streams during a same TFRE. Another data indicator may be transmitted by base station 100 for the first transport data block of the first stream, and soft buffer SB1 may be cleared if the data indicator indicates that the first transport data block is an initial transmission, or soft buffer SB 1 may be maintained for combined decoding if the data indicator indicates that the first transport data block is a retransmission. If channel decoder CD1 is able to successfully decode the transmission/retransmission, an ACK message is generated and transmitted to base station 100 (e.g., as an element of a HARQ-ACK codeword). If channel decoder CD1 is unable to decode the transmissions/retransmissions, a NACK message is generated and transmitted to base station 100 (e.g., as an element of a HARQ-ACK codeword).

According to embodiments of FIG. 7B, first, second, and third transport data blocks may be transmitted during a same TFRE over respective the first, second, and third streams during a rank three transmission. A data indicator may be transmitted by base station 100 for both of the first and third transport data blocks of the first and second downlink data streams. If the data indicator indicates a new/initial transmission, wireless terminal 200 may clear soft buffers SB1 and SB3 and attempt to decode the first and second transport data blocks using channel decoders CD1 and CD3. If the first data indicator indicates a retransmission, wireless terminal 200 may combine soft bits of the first and third transport data blocks (generated by demodulators/deinterleavers DM1 and DM3) with soft bits from respective soft buffers SB1 and SB3 and attempt to decode the combinations using respective channel decoders CD1 and CD3. If both channel decoders CD1 and CD3 are able to successfully decode the transmissions/retransmissions, an ACK message is generated and transmitted to base station 100 (e.g., as an element of a shared HARQ-ACK codeword). If either of channel decoders CD1 or CD3 is unable to decode the transmissions/retransmissions, a NACK message is generated and transmitted to base station 100 (e.g., as an element of a shared HARQ-ACK codeword). The first HARQ process (e.g., HARQ-1 including a single data indicator and a single ACK/NACK message) may thus be shared by two transport data blocks transmitted over different downlink data streams during a same TFRE. Another data indicator may be transmitted by base station 100 for the second transport data block of the second stream, and soft buffer SB2 may be cleared if the second data indicator indicates that the second transport data block is an initial transmission, or soft buffer SB2 may be maintained for combined decoding if the second data indicator indicates that the second transport data block is a retransmission.

If channel decoder CD2 is able to successfully decode the transmission/retransmission, an ACK message is generated and transmitted to base station 100 (e.g., as an element of a HARQ-ACK codeword). If channel decoder CD2 is unable to decode the transmissions/retransmissions, a NACK message is generated and transmitted to base station 100 (e.g., as an element of a HARQ-ACK codeword).

For rank/layer four downlink transmissions according to embodiments of FIG. 7A, the first HARQ process (HARQ-1) may be shared between a first stream (e.g., for a downlink stream transmitted using TB1, CE1, IM1, and/or SS1 defining a first transmission layer and received using DM1, SB1, and/or CD1 defining a first reception layer) and a second stream (e.g., for a downlink stream transmitted using TB2, CE2, IM2, and/or SS2 defining a second transmission layer and received using DM2, SB2, and/or CD2 defining a second reception layer), and the second HARQ process (HARQ-2) may be shared between a third stream (e.g., for a downlink stream transmitted using TB3, CE3, IM3, and/or SS3 defining a third transmission layer and received using DM3, SB3, and/or CD3 defining a third reception layer) and a fourth stream (e.g., for a downlink stream transmitted using TB4, CE4, IM4, and/or SS4 defining a fourth transmission layer and received using DM4, SB4, and/or CD4 defining a fourth reception layer). For rank/layer four downlink transmissions according to embodiments of FIG. 7B, the first HARQ process (HARQ-1) may be shared between a first stream (e.g., for a downlink stream transmitted using TB1, CE1, IM1, and/or SS1 defining a first transmission layer and received using DM1, SB1, and/or CD1 defining a first reception layer) and a third stream (e.g., for a downlink stream transmitted using TB3, CE3, IM3, and/or SS3 defining a third transmission layer and received using DM3, SB3, and/or CD3 defining a third reception layer), and the second HARQ process (HARQ-2) may be shared between a second stream (e.g., for a downlink stream transmitted using TB2, CE2, IM2, and/or SS2 defining a second transmission layer and received using DM2, SB2, and/or CD2 defining a second reception layer) and a fourth stream (e.g., for a downlink stream transmitted using TB4, CE4, IM4, and/or SS4 defining a fourth transmission layer and received using DM4, SB4, and/or CD4 defining a fourth reception layer). For rank/layer four downlink transmissions according to embodiments of FIG. 7C, the first HARQ process (HARQ-1) may be shared between a first stream (e.g., for a downlink stream transmitted using TB1, CE1, IM1, and/or SS1 defining a first transmission layer and received using DM1, SB1, and/or CD1 defining a first reception layer) and a fourth stream (e.g., for a downlink stream transmitted using TB4, CE4, IM4, and/or SS4 defining a fourth transmission layer and received using DM4, SB4, and/or CD4 defining a fourth reception layer), and the second HARQ process (HARQ-2) may be shared between a second stream (e.g., for a downlink stream transmitted using TB2, CE2, IM2, and/or SS2 defining a second transmission layer and received using DM2, SB2, and/or CD2 defining a second reception layer) and a third stream (e.g., for a downlink stream transmitted using TB3, CE3, IM3, and/or SS3 defining a third transmission layer and received using DM3, SB3, and/or CD3 defining a third reception layer).

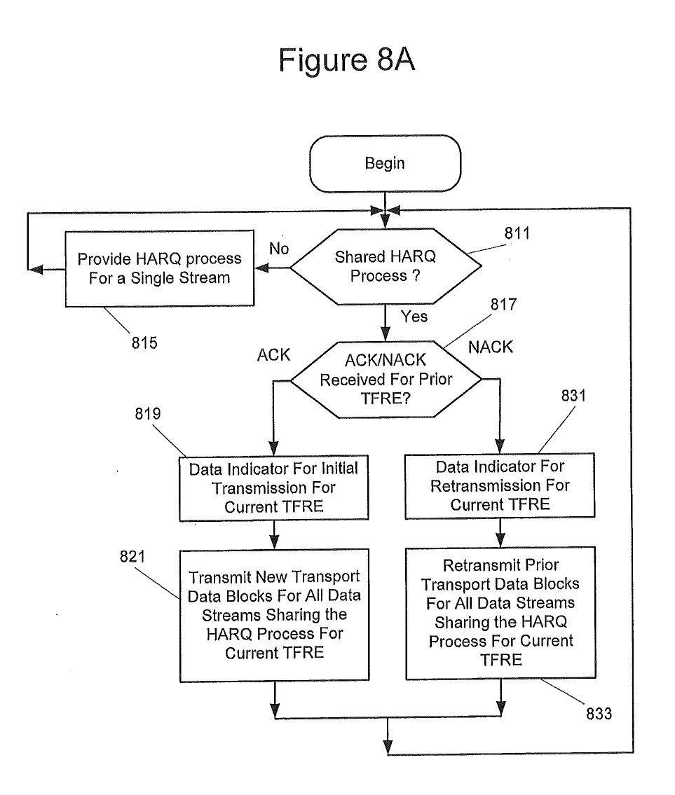

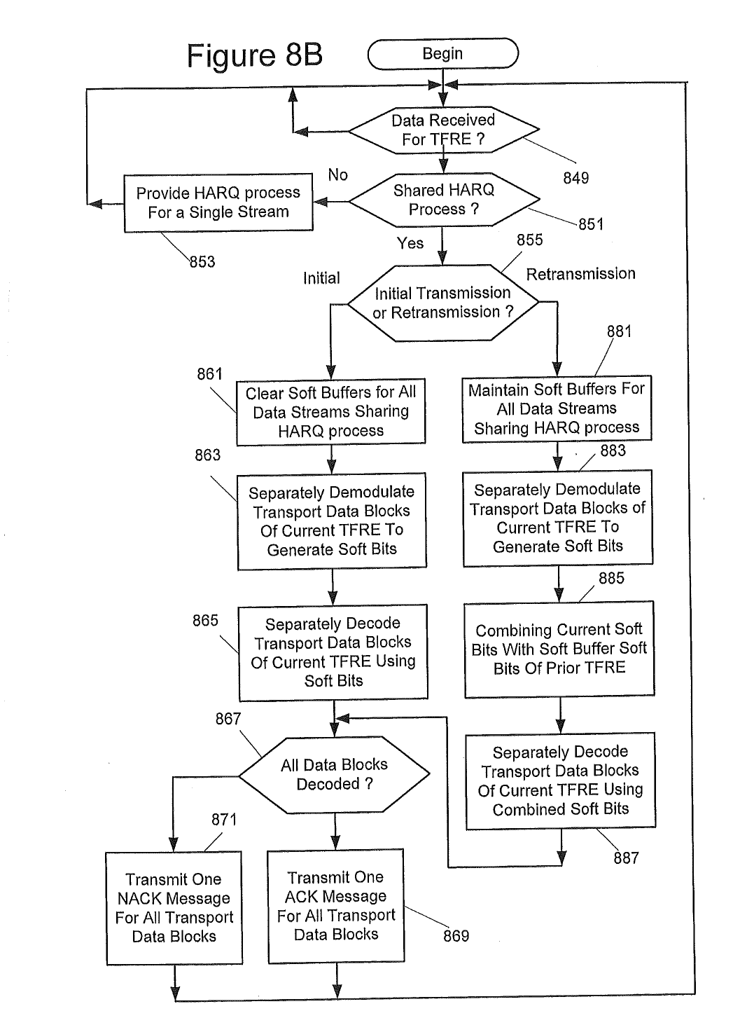

The sharing of a HARQ process between any two data streams during rank four transmission/reception may be the same as discussed above with respect the sharing of HARQ processes between two data streams during rank three transmissions. Where a HARQ process is shared between two streams, the HARQ process provides one data indicator and one ACK/NACK message for each TFRE for all data streams sharing the HARQ process. Operations of a HARQ process shared by multiple data streams will now be discussed in greater detail below with respect to the flow charts of FIGS. 8A and 8B.

FIG. 8A illustrates operations of base station 100 transmitting multiple MIMO data streams using a shared HARQ process according to some embodiments of present inventive concepts, and FIG. 8B illustrates operations of wireless terminal 200 receiving multiple MIMO data streams using a shared HARQ process according to some embodiments of present inventive concepts. Operations of FIGS. 8A and 8B may be discussed concurrently because the base station and wireless terminal operations may be interleaved.

As shown in FIG. 8A, base station processor 101 may determine for a HARQ process if the HARQ process is being applied to a single MIMO data stream or if the HARQ process is being shared by multiple (e.g., two) MIMO data streams at block 811. If the HARQ process is being applied to only one MIMO data stream, the HARQ process may be applied individually to the single MIMO data stream at block 815 so that one ACK/NACK message (received from wireless terminal 200) from the prior TFRE is applied only to the single MIMO data stream for the current TFRE, and so that one data indicator is applied only to the single MIMO data stream for the current TFRE.

If the HARQ process is being shared by multiple MIMO data streams at block 811, base station processor 101, may determine whether an ACK message or a NACK message was received in response to transport data blocks transmitted over the multiple MIMO data streams in a/the preceding TFRE. As discussed above, one ACK or NACK message may be transmitted by wireless terminal 200 for a plurality data streams sharing a HARQ process.

If an ACK message was received for the prior TFRE transmission at block 817, base station processor 101 may generate and transmit a data indicator indicating an initial transmission of new data for all transport data blocks being transmitted during the current TFRE for the data streams sharing the HARQ process at block 819. At block 821, base station processor 101 may generate and transmit new transport data blocks for all data streams sharing the HARQ process.

If a NACK message was received for the prior TFRE transmission at block 817, base station processor 101 may generate and transmit a data indicator indicating a retransmission of the prior data for all transport data blocks being transmitted during the current TFRE for the data streams sharing the HARQ process at block 831. At block 833, base station processor 101 may retransmit the previously transmitted transport data blocks for all data streams sharing the HARQ process. A single NACK message may thus result in retransmission of transport data blocks for all data streams sharing the HARQ process.

As shown in FIG. 8B, responsive to receiving data for a TFRE at block 849, wireless terminal processor 201 may determine for a HARQ process if the HARQ process is being applied to a single MIMO data stream or if the HARQ process is being shared by multiple (e.g., two) MIMO data streams at block 851. If the HARQ process is being applied to only one MIMO data stream, the HARQ process may be applied individually to the single MIMO data stream at block 853 so that one ACK/NACK message is generated for only the single MIMO data stream, and so that a data indicator is applied only to the single MIMO data stream for the current TFRE. As discussed above with respect to a four antenna system, for example, a first HARQ process (HARQ-1) may be applied individually to a first MIMO data stream (e.g., using TB1, CE1, IM1, DM1, SB1, and/or CD1) for rank 1, rank 2, and rank 3 transmission/reception, and a second HARQ process (HARQ-2) may be applied individually to a second MIMO data stream (e.g., using TB2, CE2, IM2, DM2, SB2, and/or CD2) for rank 2 transmission/reception.

If the HARQ process is being shared by multiple MIMO data streams at block 851, wireless terminal processor 201 may determine at block 855 whether a data indicator (transmitted by base station 100) indicates that the transport data blocks are initial transmissions of new data or retransmissions of old data transmitted in a previous TFRE. As discussed above with respect to a four antenna system, for example, a first HARQ process (HARQ-1) may be shared by a first MIMO data stream (e.g., using TB1, CE1, IM1, DM1, SB1, and/or CD1) and a fourth MIMO data stream (e.g., using TB4, CE4, IM4, DM4, SB4, and/or CD4) for rank 4 transmission/reception, and a second HARQ process (HARQ-2) may be shared by a second MIMO data stream (e.g., using TB2, CE2, IM2, DM2, SB2, and/or CD2) and a third MIMO data stream (e.g., using TB3, CE3, IM3, DM3, SB3, and/or CD3) for rank 3 and rank 4 transmission/reception.

If the transport data blocks of the shared HARQ process are initial transmissions of new data, all soft buffers of the data streams sharing the HARQ process are cleared at block 861 (responsive to the one data indicator), and each of the transport data blocks of the data streams sharing the HARQ process are separately demodulated at block 863 to generate soft bits for the respective transport data blocks. The soft bits for the respective transport data blocks are then decoded at bock 865 to generate the original transport data blocks. If all of the current transport data blocks (of the current TFRE) of the MIMO data streams sharing the HARQ process are successfully decoded at block 867, one ACK message may be generated and transmitted to base station 100 at block 869 for all of the transport data blocks sharing the HARQ process. If one of the current transport data blocks (of the current TFRE) of the MIMO data streams sharing the HARQ process fails decoding at block 867, one NACK message may be generated and transmitted to base station 100 at block 871 for all of the transport data blocks sharing the HARQ process.

If the transport data blocks of the shared HARQ process are retransmissions, all soft buffers of the data streams sharing the HARQ process are maintained at block 881 (responsive to the one data indicator), and each of the transport data blocks of the data streams sharing the HARQ process are separately demodulated at block 883 to generate soft bits for the respective transport data blocks. The soft bits for the respective transport data blocks are then combined with the corresponding soft bits from respective soft buffers at block 885, and the combinations of old/new soft bits are separately decoded at bock 887 to generate the original transport data blocks. If all of the current transport data blocks (of the current TFRE) of the MIMO data streams sharing the HARQ process are successfully decoded at blocks 887 and 867, one ACK message may be generated and transmitted to base station 100 at block 869 for all of the transport data blocks sharing the HARQ process. If one of the current transport data blocks (of the current TFRE) of the MIMO data streams sharing the HARQ process fails decoding at block 867, one NACK message may be generated and transmitted to base station 100 at block 871 for all of the transport data blocks sharing the HARQ process.

In a multiple HARQ process/codeword MIMO system supporting up to four MIMO data streams with HARQ codeword dimensioning, for example, two HARQ processes/codewords may be mapped to three MIMO data streams/layers for rank 3 transmissions and to four MIMO data streams/layers for rank 4 transmissions. For rank three downlink transmissions according to embodiments of FIG. 7B, for example, a first HARQ process (HARQ-1) may map to each transport data block transmitted over a first stream of the rank three transmission (e.g., for a downlink stream transmitted using TB1, CE1, IM1, and/or SS1 defining a first transmission layer TL1 and received using DM1, SB1, and/or CD1 defining a first reception layer RL1) and to each transport data block transmitted over a third stream of the rank three transmission (e.g., for a downlink stream transmitted using TB3, CE3, IM3, and/or SS3 defining a second transmission layer TL3 and received using DM3, SB3, and/or CD3 defining a third reception layer RL3); and a second HARQ process (HARQ-2) may map to each transport data block transmitted over a second stream of the rank three transmission (e.g., for a downlink stream transmitted using TB2, CE2, IM2, and/or SS2 defining a second transmission layer TL2 and received using DM2, SB2, and/or CD2 defining a second reception layer RL2). For rank four downlink transmissions according to embodiments of FIG. 7B, for example, the first HARQ process (HARQ-1) may map to each transport data block transmitted over a first stream of the rank four transmission (e.g., for a downlink stream transmitted using TB1, CE1, IM1, and/or SS1 defining a first transmission layer TL1 and received using DM1, SB1, and/or CD1 defining a first reception layer RL4) and to each transport data block transmitted over a third stream of the rank four transmission (e.g., for a downlink stream transmitted using TB3, CE3, IM3, and/or SS3 defining a second transmission layer TL3 and received using DM3, SB3, and/or CD3 defining a second reception layer RL3); and the second HARQ process (HARQ-2) may map to each transport data block transmitted over a second stream of the rank four transmission (e.g., for a downlink stream transmitted using TB2, CE2, IM2, and/or SS2 defining a second transmission layer TL2 and received using DM2, SB2, and/or CD2 defining a second reception layer TL2) and over a fourth stream of the rank four transmission (e.g., for a downlink stream transmitted using TB4, CE4, IM4, and/or SS4 defining a fourth transmission layer TL4 and received using DM4, SB4, and/or CD4 defining a fourth reception layer RL4). This sharing of HARQ processes may be referred to as bundling and/or sharing. While embodiments of FIG. 7B are discussed by way of example, embodiments of FIG. 7A or embodiments of FIG. 7C may be used.

As further discussed above, if either data block sharing a HARQ process is not successfully decoded at the respective channel decoder (e.g., if a data block fails at either of channel decoders CD1 or CD3 sharing the first HARQ process (HARQ-1) during a rank 3 or a rank 4 transmission, or if a data block fails at either of channel decoders CD2 or CD4 sharing the second HARQ process (HARQ-2) during a rank 4 transmission, according to embodiments of FIG. 7B, a single NACK for the bundled/shared HARQ process may be transmitted to base station 100 and soft bits for both of the failed data blocks may be saved at respective soft buffers (corresponding to the respective channel decoders and/or HARQ processes) for subsequent combining with retransmissions of the failed data blocks. If the transmission rank requested by wireless terminal 200 changes between transmitting the initial data blocks and retransmitting the failed data blocks, however, the retransmission may be complicated if the updated rank does not support the shared HARQ process for the failed data blocks. More particularly, the soft buffers may be mapped to respective HARQ processes=so that the soft bits saved in one or both of the respective soft buffers may be unavailable if the mapping of the bundled HARQ process according to the updated transmission rank does not include both soft buffers. Accordingly, base station 100 may be unable to retransmit the failed bundled data blocks using the updated rank thereby increasing delay in retransmitting the failed bundled data blocks.

In a rank 3 or a rank 4 transmission using one TFRE to transmit three or four data blocks according to embodiments of FIG. 7B, for example, a first data block may be transmitted using a first transmission layer TL1 (e.g., including TB1, CE1, IM1, and/or SS1) and received using a first reception layer RL1 (e.g., including DM1, SB1, and/or CD1), and a third data block may be transmitted using a third transmission layer TL3 (e.g., including TB3, CE3, IM3, and/or SS3) and received using a third reception layer RL3 (e.g., including DM3, SB3, and/or CD3). If either or both of the first or third data blocks fails decoding at respective channel decoder CD1 and/or CD3, wireless terminal 200 may transmit a single NACK message to base station 100 indicating failure of the bundled first and third data packets, and soft bits of the first and third data blocks (from respective demodulators/deinterleavers DM1 and DM3) may be saved at respective soft buffers SB 1 and SB3 for subsequent combining with retransmissions of the first and second data blocks. If the transmission rank is reduced to rank 1 or rank 2, however, transmission/reception along the third transmission layer TL3 (e.g., including TB3, CE3, IM3, and/or SS3) and the third reception layer RL3 (e.g., including DM3, SB3, and/or CD3) may no longer be supported so that parallel retransmission of the first and third data packets using the first HARQ process HARQ-1 (including both soft buffers SB1 and SB3) may not be possible.

Similarly, in a rank 4 transmission using one TFRE according to embodiments of FIG. 7B, for example, a second data block may be transmitted using a second transmission layer TL2 (e.g., including TB2, CE2, IM2, and/or SS2) and received using a second reception layer RL2 (e.g., including DM2, SB2, and/or CD2), and a fourth data block may be transmitted using a fourth transmission layer TL4 (e.g., including TB4, CE4, IM4, and/or SS4) and received using a fourth reception layer RL4 (e.g., including DM4, SB4, and/or CD4). If either or both of the second and/or fourth data blocks fails decoding at respective channel decoder CD2 and/or CD4, wireless terminal 200 may transmit a single NACK message to base station 100 indicating failure of the bundled second and fourth data blocks, and soft bits of the second and fourth data blocks (from respective demodulators/deinterleavers DM2 and DM4) may be saved at respective soft buffers SB2 and SB4 for subsequent combining with retransmissions of the second and fourth data blocks. If the transmission rank is reduced to rank 1, rank 2, or rank 3, however, transmission/reception along the second and/or fourth transmission/reception layers may no longer be supported so that parallel retransmission of the second and fourth data packets using the second HARQ process HARQ-2 (including both soft buffers SB2 and SB4) may not be possible.

According to some embodiments, wireless terminal processor 201 and/or base station processor 101 may delay changing a downlink transmission rank for wireless terminal 200 until either ACKs have been received for all data blocks previously transmitted to wireless terminal 200 or a maximum number of retransmissions have occurred. Accordingly, mappings of HARQ processes=to transmission/reception layers (including respective soft buffers) may be maintained as needed for retransmissions of any failed data blocks that were initially transmitted using a shared/bundled HARQ process. Because downlink channel conditions may vary at a relatively low rate over two to three consecutive transmission time intervals, however, a relatively low transmission quality of the downlink channel which resulted in the initial channel decoder failure may remain relatively low so that a higher number of retransmissions may be needed to achieve successful decoding and CRC validation of the failed data block(s). The increased number of retransmissions, however, may increase delay transferring the data block(s) to higher processing layers, and/or an increased residual block error rate may occur.

As discussed above with respect to FIGS. 3A, 3B, and 3C, wireless terminal 200 may generate channel state information (CSI) that is transmitted to base station 100 over a feedback channel, and the channel state information may include a precoding index (PCI) identifying a precoding vector and/or a rank indicator (RI) identifying a rank that is recommended for a subsequent downlink data transmission(s). The precoding index and/or rank indicator may be selected by wireless terminal processor 101 responsive to the channel estimate that is calculated using the pilot signals received from base station 100 and responsive to ACKs/NACKs generated by the respective HARQ processes. In a four antenna MIMO system, for example, the precoding codebook may include 16 precoding vectors for each of the four ranks, so that the precoding codebook may include a total of 64 different precoding vectors.

According to some embodiments, wireless terminal processor 201 may consider each of the precoding vectors (for all ranks) of the precoding codebook (e.g., 64 precoding vectors) when selecting a precoding vector. More particularly, wireless terminal processor 201 may use a most recent channel estimate (based on the received pilot signals) to compute a signal-to-noise-ratio (SNR) for each precoding vector of the codebook (e.g., computing 64 different SNRs), and wireless terminal processor 201 may then compute a capacity for each of the precoding vectors of the codebook using the formula C=Log₂(1+SNR). A precoding vector and corresponding rank may then be selected based on the computed capacities to increase/maximize capacity. Further calculations may be performed based on the computed SNRs to choose a suitable modulation and coding scheme (e.g., using lookup tables), and the selected precoding vector, rank, and/or modulation and coding scheme may be included in the channel state information that is transmitted to base station 100 over the feedback channel.

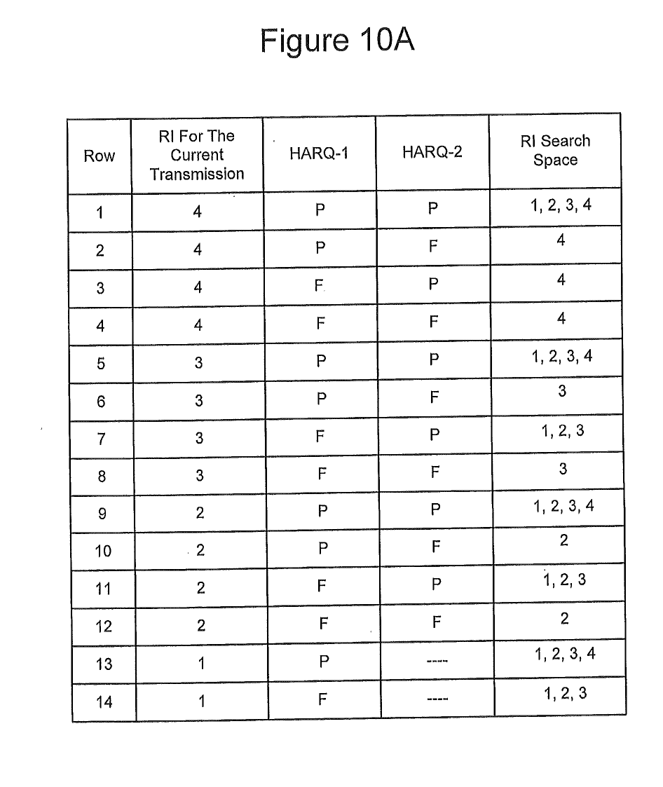

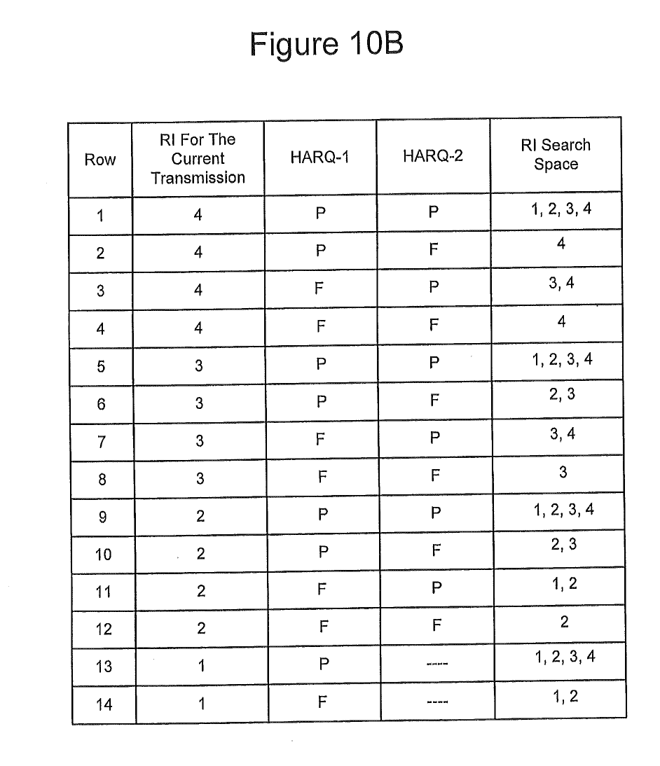

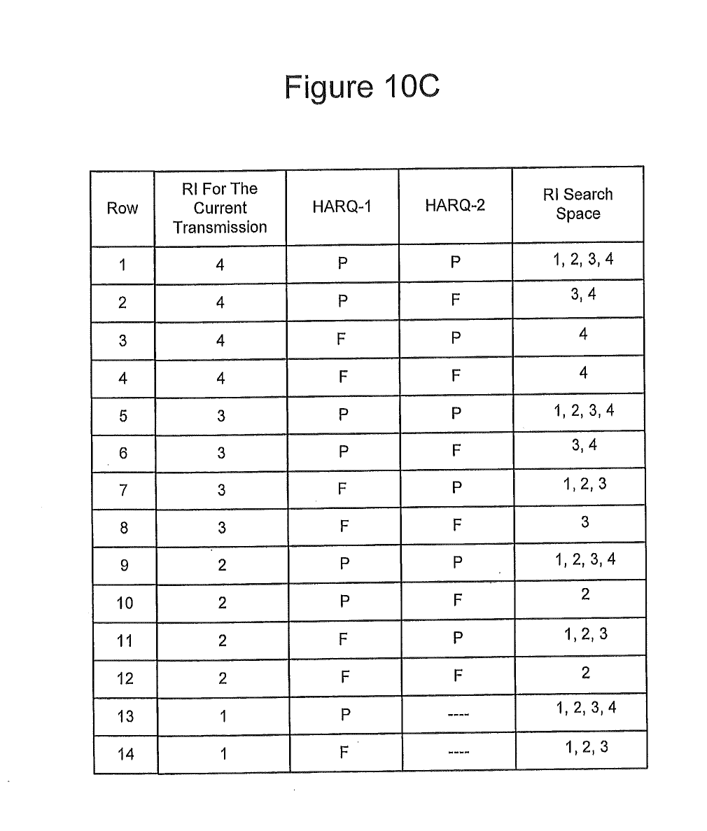

As discussed in greater detail below with respect to FIGS. 10A, 10B, and 10C, however, if wireless terminal processor 201 supporting bundled HARQ processes-fails to successfully decode a downlink transport data block resulting in transmission of at least one HARQ NACK back to base station 100 for a time resource element, rank and precoding vector selection may be restricted to support retransmission of the data block(s) corresponding to the HARQ NACK message. Accordingly, wireless terminal processor 201 may restrict consideration of ranks and precoding vectors to only those ranks and corresponding precoding vectors that support retransmission of the data block(s) corresponding to the HARQ NACK message for the time resource element. By reducing the precoding vector search space to precoding vectors for ranks available for a subsequent transmission, time and/or processing overhead required to select a precoding vector may be reduced.

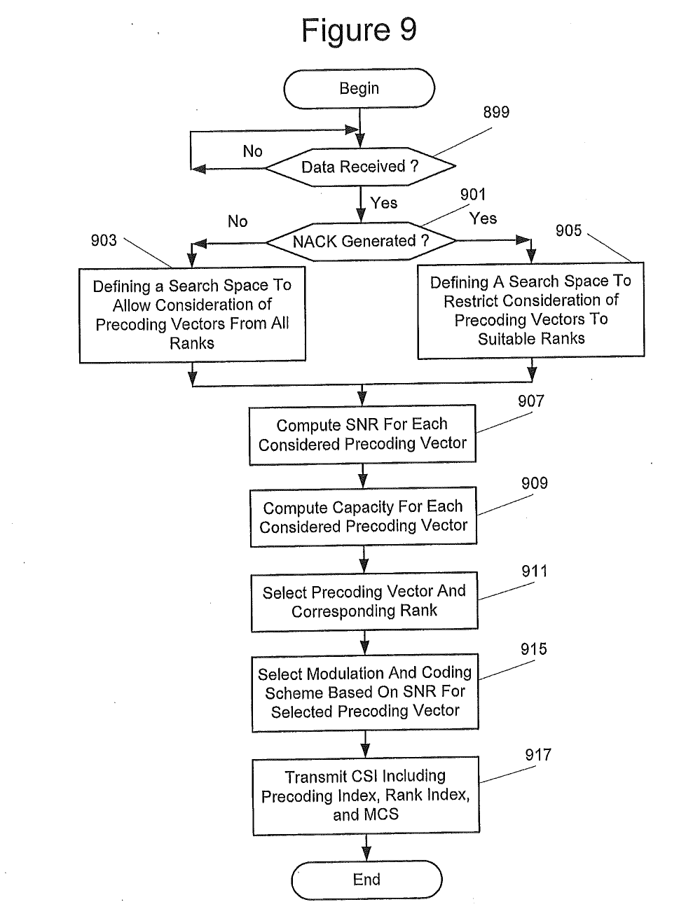

According to some embodiments of present inventive concepts, wireless terminal processor 201 may select precoding vectors according to operations of FIG. 9. Operations of FIG. 9 may be initiated each time channel state information (CSI) is reported over the feedback channel to base station 100. Channel state information, for example, may be reported for each transmission time interval (also referred to as a TFRE) over which a downlink data block(s) is received from base station 100, or channel state information may be reported more or less frequently. Wireless terminal processor 201 and/or transceiver 209 may define a plurality of reception layers/streams as discussed above with respect to FIGS. 4 and/or 5: with a first layer RL1 being used for MIMO ranks 1, 2, 3, and 4; with a second layer RL2 being used for MIMO ranks 2, 3, and 4; with a third layer RL3 being used for MIMO ranks 3 and 4; and with a fourth MIMO layer RL4 being used for MIMO rank 4. Separate decoding (e.g., using decoder functionally illustrated by decoders CD1-4 of FIG. 5) may be performed for each MIMO layer received during a MIMO TTI. Wireless terminal processor 201, for example, may define, configure, and/or use one or more of reception layers RL1, RL2, RL3, and/or RL4 for a given TTI/TFRE responsive to rank and/or precoding vector information provided from base station 100 via downlink signaling as discussed above with respect to FIG. 3A. For example, a higher MIMO rank (defining a respective higher number of reception layers/streams) may be selected when the wireless terminal detects that the downlink channel has a higher SINR (e.g., when the wireless terminal is relatively close to the base station), and a lower MIMO rank (defining a respective lower number of reception layers/streams) may be selected when the wireless terminal detects that the downlink channel has a lower SINR (e.g., when the wireless terminal is relatively distant from the base station).

While separate transport block generator, encoder, modulator, layer mapper, spreader/scrambler, and layer precoder blocks are illustrated in FIG. 4 by way of example, the blocks of FIG. 4 merely illustrate functionalities/operations of base station processor 101 and/or transceiver 109. Sub-blocks (e.g., transport blocks TB1-TB4 channel encoders CE1-CE4, interleavers/modulators IM1-IM4, and spreader scramblers SS1-SS4) of FIG. 4 further illustrate functionalities/operations of transport block generator, encoder block, modulator block, and spreader/scrambler block supporting transmission layers TL1-TL4. Processor 101, however, may provide/define/configure functionality/operations of only one transmission layer TL1 during rank 1 transmission; processor 101 may provide/define/configure functionality/operations of only two transmission layers TL1 and TL2 during rank 2 transmission; processor 101 may provide/define/configure functionality/operations of only 3 transmission layers TL1, TL2, and TL3 during rank 3 transmission; and functionality/operations of four transmission layers TL1, TL2, TL3, and TL4 may only be provided during rank 4 transmission. When multiple transmission layers are provided/defined/configured, for example, processor 101 may provide/define/configure functionality/operations of multiple transport block sub-blocks, multiple channel decoder sub-blocks, multiple interleaver/modulator sub-blocks, and/or multiple spreader/scrambler sub-blocks to allow parallel processing of data of different transmission layers before transmission during a TTI/TFRE, or processor 101 may provide/define/configure functionality/operations of a single transport block, a single channel encoder, a single interleaver/modulator, and/or a single spreader scrambler to allow serial processing of data of different transmission layers before transmission during a TTI/TFRE.

While separate layer decoder, layer demapper, demodulator/deinterleaver, soft buffer, channel decoder, and transport block combiner blocks/sub-blocks are illustrated in FIG. 5 by way of example, the blocks of FIG. 5 merely illustrate functionalities/operations of wireless terminal processor 201 and/or transceiver 209. For example, sub-blocks (e.g., demodulator/deinterleaver DM1-DM4, soft buffers SB1-SB4, and channel decoders CD1-CD4) of FIG. 5 illustrate functionalities/operations providing reception layers RL1-RL4. Processor 101, however, may provide/define/configure functionality/operations of only one reception layer RL1 during rank 1 reception; processor 101 may provide/define/configure functionality/operations of only two reception layers RL1 and RL2 during rank 2 transmission; processor 101 may provide/define/configure functionality/operations of only 3 reception layers RL1, RL2, and RL3 during rank 3 transmission; and functionality/operations of four reception layers RL1, RL2, RL3, and RL4 may only be provided during rank 4 transmission. When multiple reception layers are provided/defined/configured, for example, processor 101 may provide/define/configure functionality/operations of multiple demodulator/deinterleaver blocks, multiple soft buffer blocks, and/or multiple channel decoder blocks to allow parallel processing of data of different reception layers during a TTI/TFRE, or processor 101 may provide/define/configure functionality/operations of a single demodulator/deinterleaver block, a single soft buffer, and/or a single channel decoder to allow serial processing of data of different reception layers during a TTI/TFRE.

At block 901, wireless terminal processor 201 may determine if a HARQ NACK has been generated for any downlink data blocks of the respective transmission time interval. If a rank 1 transmission/reception occurred during the respective TTI (received over first reception layer including DM1 and CD1), then a single unbundled HARQ ACK/NACK may be generated for a single unbundled HARQ process (e.g., HARQ-1). If a rank 2 transmission/reception occurred during the respective TTI (received over first reception layer including DM1 and CD1 and second reception layer including DM2 and CD2), then one unbundled HARQ ACK/NACK may be generated for one unbundled HARQ process (e.g., HARQ-1), and another unbundled HARQ ACK/NACK may be generated for another unbundled HARQ process. If a rank 3 transmission/reception occurred during the respective ITT (received over first reception layer including DM1 and CD1, second reception layer including DM2 and CD2, and third reception layer including DM3 and CD3), then a bundled HARQ ACK/NACK may be generated for a bundled HARQ process, and an unbundled HARQ ACK/NACK may be generated for an unbundled HARQ process. If a rank 4 transmission occurred during the respective TTI (received over first reception layer including DM1 and CD1, second reception layer including DM2 and CD2, third reception layer including DM3 and CD3, and fourth reception layer including DM4 and CD4), then one bundled HARQ ACK/NACK may be generated for one bundled HARQ process (e.g., HARQ-1), and another bundled HARQ ACK/NACK may be generated for another bundled HARQ process (HARQ-2).

If no NACKs are generated for any downlink data blocks of the respective transmission time interval at block 901 (i.e., all data blocks of the transmission time interval are successfully decoded so that only ACKs are generated), then wireless terminal processor 201 may allow consideration of all precoding vectors of all ranks. If any NACKs are generated for any of the downlink data blocks of the respective transmission time interval at block 901 (i.e., if any one or more of the data blocks of the transmission time interval is not successfully decoded so that at least one NACK is generated), then wireless terminal processor 201 may restrict consideration of precoding vectors to suitable ranks as discussed in greater detail below with respect to FIGS. 10A, 10B, and 10C. By restricting the number of precoding vectors being considered at block 905, processing time, processing overhead, and/or power consumption required to selecting a precoding vector may be reduced.

According to embodiments of FIG. 7A, a precoding vector search space may be defined according to the table of FIG. 10A. According to embodiments of FIG. 7B, a precoding vector search space may be defined according to the table of FIG. 10B. According to embodiments of FIG. 7C, a precoding vector search space may be defined according to the table of FIG. 10C. In each of FIGS. 10A, 10B, and 10C: the column “RI for the current transmission” identifies the MIMO rank of the current transmission; the column “HARQ-1” identifies the output of the first HARQ process for the current transmission/reception (“P”=ACK, and “F”=NACK); the column “HARQ-2” identifies the output of the second HARQ process for the current transmission/reception (“P”=ACK, “F”=NACK, and “----” indicates that the second HARQ process is unused); and the column “RI Search Space” identifies the ranks for which precoding vectors may be considered. As discussed above, in a system supporting 4 layer MIMO transmission/reception, the precoding codebook may include 16 precoding vectors for each rank.

As shown in rows 1, 5, 9, and 13 of FIGS. 10A, 10B, and 10C, if all active HARQ processes (i.e., HARQ-1 for rank 1 transmission/reception, or HARQ-1 and HARQ-2 for rank 2, 3, or 4 transmission/reception) generate an ACK (i.e., all data blocks of the respective TTI are successfully decoded), then wireless terminal processor 201 may allow consideration of precoding vectors of ranks 1, 2, 3, and 4 so that all 64 precoding vectors of the codebook are considered. Stated in other words, a search space for the precoding vector may include all 64 precoding vectors of the precoding code book. Because no retransmission will be required, there is no need to maintain mappings between a HARQ process(es) and respective transmission/reception layer(s). Accordingly, wireless terminal processor 201 may select a precoding vector most suitable for current channel conditions.

According to embodiments of FIG. 7A, the search space for precoding vectors may be restricted responsive to one or more NACKs as shown in FIG. 10A. As shown in rows 2, 3, and 4 of FIG. 10A for rank 4 transmission/reception, if either HARQ process (HARQ-1 and/or HARQ-2) generates a NACK (indicated by “F”), then wireless terminal processor 201 may restrict consideration of preceding vectors to precoding vectors of rank 4 so that only 16 precoding vectors of the precoding codebook are selected for consideration at block 905. As shown in rows 6 and 8 of FIG. 10A for rank 3 transmission/reception, if the second HARQ process (HARQ-2) generates a NACK, then wireless terminal processor 201 may restrict consideration of precoding vectors to precoding vectors of rank 3 so that only 16 precoding vectors of the precoding codebook are selected for consideration at block 905. As shown in row 7 of FIG. 10A for rank 3 transmission, if the first HARQ process (HARQ-1) generates a NACK and the second HARQ process (HARQ-2) generates an ACK, then wireless terminal processor 201 may restrict consideration of precoding vectors to precoding vectors of ranks 1, 2, and 3 so that only 48 precoding vectors of the precoding codebook are selected for consideration at block 905. As shown in rows 10 and 12 of FIG. 10A for rank 2 transmission/reception, if the second HARQ process (HARQ-2) generates a NACK, then wireless terminal processor 201 may restrict consideration of precoding vectors to precoding vectors of rank 2 so that only 16 precoding vectors of the precoding codebook are selected for consideration at block 905. As shown in row 11 of FIG. 10A for rank 2 transmission, if the first HARQ process (HARQ-1) generates a NACK and the second HARQ process (HARQ-2) generates an ACK, then wireless terminal processor 201 may restrict consideration of precoding vectors to precoding vectors of ranks 1, 2, and 3 so that only 48 precoding vectors of the precoding codebook are selected for consideration at block 905. As shown in row 14 of FIG. 10A for rank 1 transmission, if the first HARQ process (HARQ-1) generates a NACK, then wireless terminal processor 201 may restrict consideration of precoding vectors to precoding vectors of ranks 1, 2, and 3 so that only 48 precoding vectors of the precoding codebook are selected for consideration at block 905.

According to embodiments of FIG. 7B, the search space for precoding vectors may be restricted responsive to one or more NACKs as shown in FIG. 10B. As shown in rows 2 and 4 of FIG. 10B for rank 4 transmission/reception, if the second HARQ process (HARQ-2) generates a NACK (indicated by “F”), then wireless terminal processor 201 may restrict consideration of preceding vectors to precoding vectors of rank 4 so that only 16 precoding vectors of the precoding codebook are selected for consideration at block 905. As shown in row 3 of FIG. 10B for rank 4 transmission/reception, if the first HARQ process (HARQ-1) generates a NACK and the second HARQ process (HARQ-2) generates an ACK (indicated by “P”), then wireless terminal processor 201 may restrict consideration of preceding vectors to precoding vectors of ranks 3 and 4 so that only 32 precoding vectors of the precoding codebook are selected for consideration at block 905. As shown in row 6 of FIG. 10B for rank 3 transmission/reception, if the first HARQ process (HARQ-1) generates an ACK and the second HARQ process (HARQ-2) generates a NACK, then wireless terminal processor 201 may restrict consideration of precoding vectors to precoding vectors of ranks 2 and 3 so that only 32 precoding vectors of the precoding codebook are selected for consideration at block 905. As shown in row 7 of FIG. 10B for rank 3 transmission/reception, if the first HARQ process (HARQ-1) generates a NACK and the second HARQ process (HARQ-2) generates an ACK, then wireless terminal processor 201 may restrict consideration of precoding vectors to precoding vectors of ranks 3 and 4 so that only 32 precoding vectors of the precoding codebook are selected for consideration at block 905. As shown in row 8 of FIG. 10B for rank 3 transmission, if both of the first and second HARQ processes (HARQ-1 and HARQ-2) generate NACKs, then wireless terminal processor 201 may restrict consideration of precoding vectors to precoding vectors of rank 3 so that only 16 precoding vectors of the precoding codebook are selected for consideration at block 905. As shown in row 10 of FIG. 10B for rank 2 transmission/reception, if the first HARQ process (HARQ-1) generates an ACK and the second HARQ process (HARQ-2) generates a NACK, then wireless terminal processor 201 may restrict consideration of precoding vectors to precoding vectors of ranks 2 and 3 so that only 32 precoding vectors of the precoding codebook are selected for consideration at block 905. As shown in row 11 of FIG. 10B for rank 2 transmission/reception, if the first HARQ process (HARQ-1) generates a NACK and the second HARQ process (HARQ-2) generates an ACK, then wireless terminal processor 201 may restrict consideration of precoding vectors to precoding vectors of ranks 1 and 2 so that only 32 precoding vectors of the precoding codebook are selected for consideration at block 905. As shown in row 12 of FIG. 10B for rank 2 transmission, if both of the first and second HARQ processes (HARQ-1 and HARQ-2) generate NACKs, then wireless terminal processor 201 may restrict consideration of precoding vectors to precoding vectors of rank 2 so that only 16 precoding vectors of the precoding codebook are selected for consideration at block 905. As shown in row 14 of FIG. 10B for rank 1 transmission, if the first HARQ process (HARQ-1) generates a NACK, then wireless terminal processor 201 may restrict consideration of precoding vectors to precoding vectors of ranks 1 and 2 so that only 32 precoding vectors of the precoding codebook are selected for consideration at block 905.

According to embodiments of FIG. 7C, the search space for precoding vectors may be restricted responsive to one or more NACKs as shown in FIG. 10C. As shown in rows 3 and 4 of FIG. 10C for rank 4 transmission/reception, if the first HARQ process (HARQ-1) generates a NACK (indicated by “F”), then wireless terminal processor 201 may restrict consideration of preceding vectors to precoding vectors of rank 4 so that only 16 precoding vectors of the precoding codebook are selected for consideration at block 905. As shown in row 2 of FIG. 10C for rank 4 transmission/reception, if the first HARQ process (HARQ-1) generates an ACK and the second HARQ process (HARQ-2) generates a NACK, then wireless terminal processor 201 may restrict consideration of preceding vectors to precoding vectors of ranks 3 and 4 so that only 32 precoding vectors of the precoding codebook are selected for consideration at block 905. As shown in row 6 of FIG. 10C for rank 3 transmission/reception, if the first HARQ process (HARQ-1) generates an ACK and the second HARQ process (HARQ-2) generates a NACK, then wireless terminal processor 201 may restrict consideration of precoding vectors to precoding vectors of ranks 3 and 4 so that only 32 precoding vectors of the precoding codebook are selected for consideration at block 905. As shown in row 7 of FIG. 10C for rank 3 transmission/reception, if the first HARQ process (HARQ-1) generates a NACK and the second HARQ process (HARQ-2) generates an ACK, then wireless terminal processor 201 may restrict consideration of precoding vectors to precoding vectors of ranks 1, 2, and 3 so that only 48 precoding vectors of the precoding codebook are selected for consideration at block 905. As shown in row 8 of FIG. 10B for rank 3 transmission, if both of the first and second HARQ processes-(HARQ-1 and HARQ-2) generate NACKs, then wireless terminal processor 201 may restrict consideration of precoding vectors to precoding vectors of rank 3 so that only 16 precoding vectors of the precoding codebook are selected for consideration at block 905. As shown in rows 10 and 12 of FIG. 10B for rank 2 transmission/reception, if the second HARQ process (HARQ-2) generates a NACK, then wireless terminal processor 201 may restrict consideration of precoding vectors to precoding vectors of rank 2 so that only 16 precoding vectors of the precoding codebook are selected for consideration at block 905. As shown in row 11 of FIG. 10B for rank 2 transmission/reception, if the first HARQ process (HARQ-1) generates a NACK and the second HARQ process (HARQ-2) generates an ACK, then wireless terminal processor 201 may restrict consideration of precoding vectors to precoding vectors of ranks 1, 2, and 3 so that only 48 precoding vectors of the precoding codebook are selected for consideration at block 905. As shown in row 14 of FIG. 10B for rank 1 transmission, if the first HARQ process (HARQ-1) generates a NACK, then wireless terminal processor 201 may restrict consideration of precoding vectors to precoding vectors of ranks 1, 2, and 3 so that only 48 precoding vectors of the precoding codebook are selected for consideration at block 905.

Once the precoding vector search spaced is defined at blocks 901, 903, and/or 905, wireless terminal processor 201 may continue with operations of blocks 907, 909, 911, 915, and 917 to select and report a requested/recommended precoding vector, a rank, and/or modulation and coding scheme. At block 907, wireless terminal processor 201 may use a most recent channel estimate (based on the received pilot signals) to compute a signal-to-noise-ratio (SNR) for each precoding vector of the codebook that has been selected for consideration in accordance with blocks 901, 903, and/or 905 as discussed above. At block 909, wireless terminal processor 201 may compute a capacity for each of the selected precoding vectors using the formula C=Log₂(1+SNR). At block 911, wireless terminal processor 201 may select a precoding vector (from the precoding vectors being considered) based on the computed capacities to increase/maximize capacity, and wireless terminal processor 201 may also select a rank corresponding to the selected precoding vector. At block 915, wireless terminal processor 201 may choose a suitable modulation and coding scheme corresponding to the computed SNR of the selected precoding vector (e.g., using lookup tables). At block 917, wireless terminal processor 201 may transmit channel state information (CSI) over the feedback channel (shown in FIG. 3A) to base station 100, with the channel state information including a precoding index PCI (identifying the selected precoding vector), a rank indicator RI (identifying the rank of the selected precoding vector), and the selected modulation and coding scheme MCS.

As discussed above with respect to FIGS. 7A, 7B, 7C, 10A, 10B, and 10C, retransmission of data blocks in a system using bundled HARQ processes=(where a NACK message may be shared for at least two data blocks transmitted/received at a wireless terminal during a same TFRE) may be supported by maintaining a mapping of the HARQ process that generated the NACK to the same transmission/reception layer or layers if a change in precoding vector and/or rank is considered. If a mapping of a HARQ process to a transmission/reception layer or layers is to be maintained, some ranks and corresponding precoding vectors may be eliminated from consideration as discussed above, and by eliminating these ranks and precoding vectors from consideration (reducing a precoding vector search space), a processing overhead and/or power consumption of wireless terminal processor 201 may be reduced. Stated in other words, operations of blocks 907 and 909 may be reduced by reducing the precoding vector search space.

In general regarding FIGS. 10A, 10B, and 10C, when one HARQ process (HARQ-1) generates an ACK during rank 1 transmission/reception and when two HARQ processes (HARQ-1 and HARQ-2) generate ACKs during rank 2, 3, or 4 transmission/reception, wireless terminal processor 201 may consider all ranks and all precoding vectors of the precoding codebook as indicated in rows 1, 5, 9, and 13 of FIGS. 10A, 10B, and 10C. When both HARQ processes (HARQ-1 and HARQ-2) generate NACKs during rank 2, 3, or 4 transmission/reception, wireless terminal processor 201 may consider only the current rank and precoding vectors of the current rank as indicated in rows 4, 8, and 12 of FIGS. 10A, 10B, and 10C. When one HARQ process that is bundled for at least two transmission/reception layers (i.e., for multiple data blocks in the same TFRE) generates a NACK (because one of the bundled data blocks fails decoding) and the other HARQ process generates an ACK, wireless terminal processor 201 may consider only ranks and precoding vectors that support bundled retransmission of the multiple data blocks corresponding to the NACK as indicated in rows 2, 3, and 6 of FIG. 10A, as indicated by rows 2, 3, and 7 of FIGS. 10B and 10C. When on unbundled HARQ process (corresponding to only one data block of the TFRE) generates a NACK and the other HARQ process generates an ACK, wireless terminal processor 201 may consider only ranks and precoding vectors that support the retransmission of the single data block using the same HARQ process and transmission/reception layer as indicated by rows 7, 10, and 11 of FIG. 10A, as indicated by rows 6, 10, and 11 of FIG. 10B, and as indicated by rows 7, 10, and 11 of FIG. 10C.

A HARQ process (e.g., HARQ-1 or HARQ-2) and a respective HARQ identification (e.g., H_a or H_b) may be used to support downlink transmissions/retransmissions from base station 100 to wireless terminal 200, and two HARQ processes and respective HARQ identifications may support HARQ ACK/NACK signaling for 4 antenna MIMO systems supporting up to 4 layer/stream downlink transmissions (and/or higher antenna systems supporting higher rank/layer transmissions). For rank 1 transmissions, first HARQ process/identification HARQ-1/H_a maps to a first transmission/reception layer (e.g., including TB1, CE1, IM1, DM1, SB1, and/or CD1). For rank 2 transmissions, first HARQ process/identification HARQ-1/H_a maps to the first transmission/reception layer, and second HARQ process/identification HARQ-2/H_a maps to a second transmission/reception layer (e.g., including TB2, CE2, IM2, DM2, SB2, and/or CD2). For rank 3 transmissions, first HARQ process/identification HARQ-1/H_a maps to the first transmission/reception layer, and second HARQ process/identification HARQ-2/H_b maps to the second transmission/reception layer and to a third transmission/reception layers (e.g., including TB3, CE3, IM3, DM3, SB3, and/or CD3). For rank 4 transmissions, first HARQ process/identification HARQ-1/H_a maps to the first transmission/reception layer and to a fourth transmission/reception layer (e.g., including TB4, CE4, IM4, DM4, SB4, and/or CD4), and second HARQ process/identification HARQ-2/H_b maps to the second and third transmission/reception layers.

Because of the delay between base station 100 transmitting a first data block(s) to wireless terminal 200 during a first downlink TTI/TFRE and receiving a HARQ ACK/NACK response(s) for the first data block(s) from wireless terminal 200, second data block(s) may be transmitted to wireless terminal 200 during a second downlink TTI/TFRE before receiving the HARQ ACK/NACK response(s) for the first data block(s). Accordingly, HARQ process identifications may be used by base station 100 to distinguish between different HARQ ACK/NACK responses for different data blocks of different downlink TTIs/TFREs transmitted to the same wireless terminal 200. Stated in other words, HARQ process identifications may be used to match HARQ ACK/NACK responses with the appropriate data block(s) and TTI/TFRE. HARQ process identifications may also be used by wireless terminal 100 to match the data block/blocks with the appropriate soft bits from respective soft buffer/buffers.

A same HARQ process identification may thus be used for the initial transmission and for each retransmission of a data block/blocks to wireless terminal 200 until either the data block/blocks is/are successfully received/decoded by wireless terminal 200 (as indicated by an ACK) or until a maximum allowed number of retransmissions have occurred. Once the data block/blocks have been successfully received/decoded or a maximum number of retransmissions has occurred, the HARQ process identification for the data block/blocks may be destroyed, meaning that the HARQ process identification may then be reused for a new data block/blocks.

Accordingly to some embodiments, a HARQ process identification may be selected from one of eight values (e.g., 1, 2, 3, 3, 5, 6, 7, or 8). For rank 1, 2, and 3 downlink transmissions to wireless terminal 200, HARQ process identification H_a is mapped to a first HARQ process HARQ-1 for layer 1 transmission using the first transmission/reception layer (e.g., including TB1, CE1, IM1, DM1, SB1, and/or CD1). For rank 4 downlink transmissions to wireless terminal, HARQ process identification H_a is mapped to the first HARQ process HARQ-1 for layer 1 and 4 transmissions using the first and fourth transmission/reception layers. For rank 2 downlink transmissions to wireless terminal 200, HARQ process identification H_b is mapped to second HARQ process HARQ-2 for layer 2 transmission using the second transmission/reception layer. For rank 3 and 4 downlink transmissions to wireless terminal, HARQ process identification H_b is mapped to the second HARQ process HARQ-2 for layer 2 and 3 transmissions using the second and third transmission/reception layers. Accordingly, HARQ process HARQ-1 and identification H_a are used for rank 1, 2, 3, and 4 transmissions, and HARQ process HARQ-2 and identification H_b are used for rank 2, 3, and 4 transmissions.

For an initial rank 1 transmission of a data block, a currently unused identification value (e.g., selected from 1-8) is assigned to H_a for HARQ process HARQ-1, and H_a is used to identify the instance of HARQ-1 that is applied to transmissions/retransmissions of the layer 1 data block and that is applied to HARQ ACK/NACK responses corresponding to the layer 1 data block.

For an initial rank 2, 3, or 4 transmission of data blocks using both HARQ processes HARQ-1 and HARQ-2 during a same TTI/TFRE, a currently unused identification value (e.g., selected from 1-8) is assigned to H_a for HARQ process HARQ-1, and another identification value is assigned to H_b for process HARQ-2 (e.g., as a function of H_a). Accordingly, H_a is used to identify the instance of HARQ-1 that is applied to transmissions/retransmissions of layer 1/4 data block/blocks (for layer 1 and/or 4 transmissions/retransmissions) and that is applied to HARQ ACK/NACK responses corresponding to the layer 1/4 data blocks, and H_b is used to identify the instance of HARQ-2 that is applied to transmissions/retransmissions of the layer 2/3 data block/blocks (for layer 2 and/or 3 transmissions/retransmissions) and that is applied to HARQ ACK/NACK responses corresponding to the layer 2/3 data block/blocks.

According to some embodiments, HARQ process identification H_b may be assigned as a function of HARQ process identification H_a. With eight different HARQ process identification values from one to eight, for example, identification H_b may be assigned according to the following formula:

H_{—}b=(H_{—}a+N/2)mod(N),

where N is the number of HARQ processes (e.g., two for HARQ-1 and HARQ-2) as configured by higher layers and/or by the radio network controller. With two HARQ processes and eight different HARQ process identification values, identification H_b may be selected as a function of H_a according to the following table:

| H_a | H_b |
|---|---|
| 1 | 5 |
| 2 | 6 |
| 3 | 7 |
| 4 | 8 |
| 5 | 1 |
| 6 | 2 |
| 7 | 3 |
| 8 | 4 |

Accordingly, only one of the HARQ process identifications (e.g., H_a) may need to be transmitted between base station 100 and wireless terminal 200, with the other HARQ process identification (e.g., H_b) being derived at the receiving device using H_a.

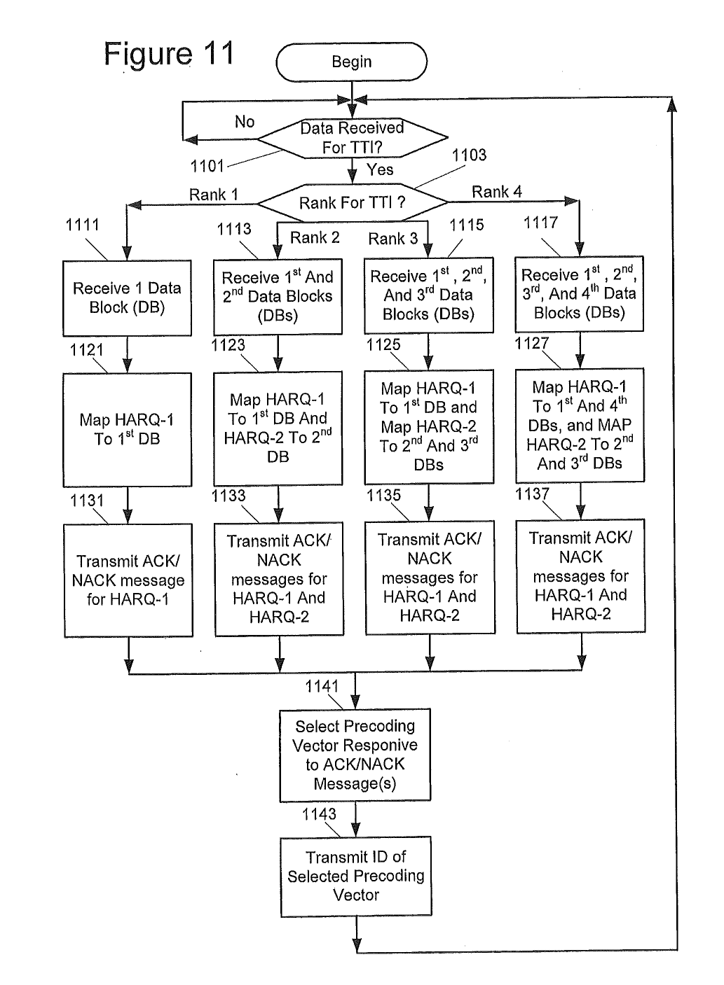

FIG. 11 is a flow chart illustrating operations of wireless terminal processor 201 and/or transceiver 209 supporting downlink reception in a four antenna/branch MIMO system supporting one, two, three, and four MIMO streams/layers. Wireless terminal processor 201 and/or transceiver 209 may define a plurality of reception layers/streams as discussed above with respect to FIGS. 4 and/or 5: with a first layer RL1 being used for MIMO ranks 1, 2, 3, and 4; with a second layer RL2 being used for MIMO ranks 2, 3, and 4; with a third layer RL3 being used for MIMO ranks 3 and 4; and with a fourth MIMO layer RL4 being used for MIMO rank 4. Separate decoding (e.g., using decoder functionally illustrated by decoders CD1-4 of FIG. 5) may be performed for each MIMO layer received during a MIMO TTI. Wireless terminal processor 201, for example, may define, configure, and/or use one or more of reception layers RL1, RL2, RL3, and/or RL4 for a given TTI/TFRE responsive to rank and/or precoding vector information provided from base station 100 via downlink signaling as discussed above with respect to FIG. 3A. For example, a higher MIMO rank (defining a respective higher number of reception layers/streams) may be selected when the wireless terminal detects that the downlink channel has a higher SINR (e.g., when the wireless terminal is relatively close to the base station), and a lower MIMO rank (defining a respective lower number of reception layers/streams) may be selected when the wireless terminal detects that the downlink channel has a lower SINR (e.g., when the wireless terminal is relatively distant from the base station).

Upon receipt of data for a transmission time interval at block 1101, processor 201 may proceed at block 1103 according to the rank (identifying the number of transmission layers/streams for the TTI). For rank 1 reception, one data block may be received using the first reception layer RL1 at block 1111 during the transmission time interval, and the first HARQ process HARQ-1 may be mapped to the data block of the first reception layer RL1 at block 1121. More particularly, mapping HARQ-1 to the data block of reception layer RL1 at block 1121 may include generating an ACK message for HARQ-1 responsive to success decoding rank one data block and generating a NACK message for HARQ-1 responsive to failure decoding the rank 1 data block, and at block 1131, processor 201 and/or transceiver may transmit the HARQ ACK/NAK message for HARQ-1 indicating success or failure decoding the data block received using reception layer RL1 for the rank 1 reception.

For rank 2 reception, first and second data blocks may be received respectively using the first and second reception layers RL1 and RL2 at block 1113 during the transmission time interval, HARQ-1 may be mapped to the first data block of the first reception layer RL1 at block 1123, and HARQ-2 may be mapped to the second data block of the second reception layer RL2 at block 1123. More particularly, mapping HARQ-1 to the first data block of reception layer RL1 at block 1123 may include generating an ACK message for HARQ-1 responsive to success decoding the first data block and generating a NACK message for HARQ-1 responsive to failure decoding the first data block, and mapping HARQ-2 to the second data block of reception layer RL2 at block 1123 may include generating an ACK message for HARQ-2 responsive to success decoding the second data block and generating a NACK message for HARQ-2 responsive to failure decoding the second data block. At block 1133, processor 201 and/or transceiver 209 may transmit the HARQ ACK/NAK messages for HARQ-1 and HARQ-2 indicating success or failure decoding the first and second data blocks received using reception layers RL1 and RL2 for the rank 2 reception.

For rank 3 reception, first, second, and third data blocks may be received respectively using the first, second, and third reception layers RL1, RL2, and RL3 at block 1115 during the transmission time interval, HARQ-1 may be mapped to the first data block of the first reception layer RL1 at block 1125, and HARQ-2 may be mapped to the second and third data blocks of the second and third reception layers RL2 and RL3 at block 1125. More particularly, mapping HARQ-1 to the first data block of reception layer RL1 at block 1125 may include generating an ACK message for HARQ-1 responsive to success decoding the first data block and generating a NACK message for HARQ-1 responsive to failure decoding the first data block. Mapping HARQ-2 to the second and third data blocks of reception layers RL2 and RL3 at block 1125 may include generating an ACK message for HARQ-2 responsive to success decoding both of the second and third data blocks and generating a NACK message for HARQ-2 responsive to failure decoding either of the second or third data blocks. At block 1135, processor 201 and/or transceiver 209 may transmit the HARQ ACK/NAK messages for HARQ-1 and HARQ-2 indicating success or failure decoding the first, second, and third data blocks received using reception layers RL1, RL2, and RL3 for the rank 3 reception.

For rank 4 reception, first, second, third, and fourth data blocks may be received respectively using the first, second, third, and fourth reception layers RL1, RL2, RL3, and RL4 at block 1117 during the transmission time interval, the HARQ-1 may be mapped to the first and fourth data blocks of the first and fourth reception layers RL1 and RL4 at block 1127, and HARQ-2 may be mapped to the second and third data blocks of the second and third reception layers RL2 and RL3 at block 1127. More particularly, mapping HARQ-1 to the first and second data blocks of reception layers RL1 and RL4 at block 1127 may include generating an ACK message for HARQ-1 responsive to success decoding both of the first and fourth data blocks and generating a NACK message for HARQ-1 responsive to failure decoding either of the first or fourth data blocks. Mapping HARQ-2 to the second and third data blocks of reception layers RL2 and RL3 at block 1127 may include generating an ACK message for HARQ-2 responsive to success decoding both of the second and third data blocks and generating a NACK message for HARQ-2 responsive to failure decoding either of the second or third data blocks. At block 1137, processor 201 and/or transceiver 209 may transmit the HARQ ACK/NAK messages for HARQ-1 and HARQ-2 indicating success or failure decoding the first, second, third, and fourth data blocks received using reception layers RL1, RL2, RL3, and RL4 for the rank 4 reception.

At block 1141, processor 201 may select a precoding vector responsive to success/failure decoding the data block or blocks of the transmission time interval as discussed above, for example, with respect to FIGS. 9 and 10A-C. At block 1143, an identification of the selected precoding vector may be transmitted to base station 100 of the radio access network. As further shown in FIG. 11, the rank may be dynamically assigned over the course of a communication between the wireless terminal 200 and base station 100, with different MIMO ranks used during different transmission time intervals.

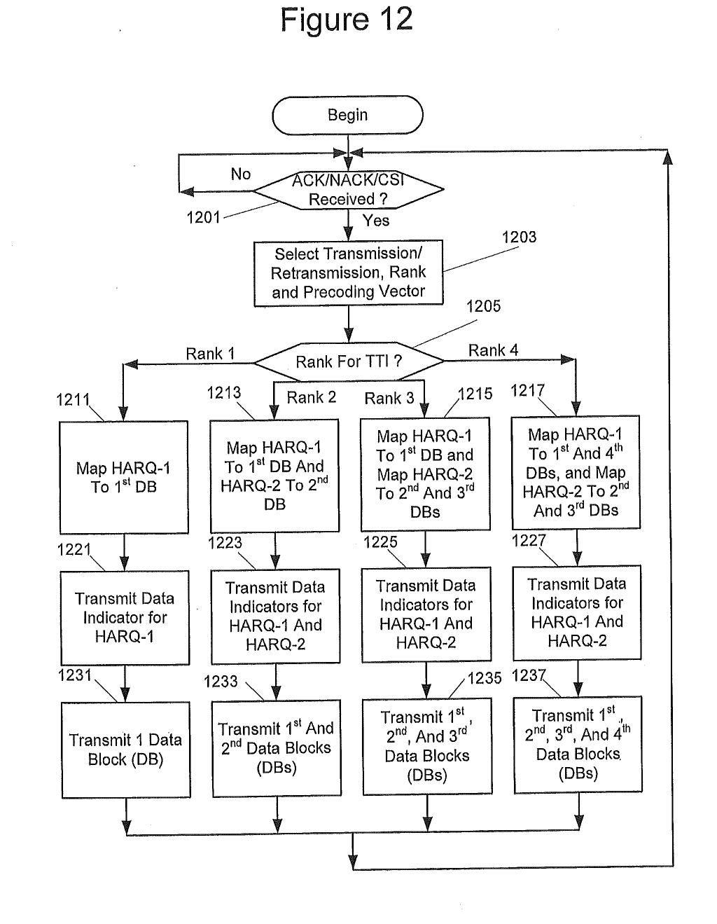

FIG. 12 is a flow chart illustrating operations of base station processor 101 and/or transceiver 109 supporting downlink transmission in a four antenna/branch MIMO system supporting one, two, three, and four MIMO streams/layers. Base station processor 101 and/or transceiver 109 may define a plurality of transmission layers/streams as discussed above with respect to FIGS. 4 and/or 5: with a first layer being used for MIMO ranks 1, 2, 3, and 4; with a second layer being used for MIMO ranks 2, 3, and 4; with a third layer being used for MIMO ranks 3 and 4; and with a fourth MIMO layer being used for MIMO rank 4. Separate encoding (e.g., using encoder functionally illustrated by encoders CE1-4 of FIG. 4) may be performed for each MIMO layer received during a MIMO TTI. Base station processor 101, for example, may select a MIMO rank defining one or more of transmission layers TL1, TL2, TL3, and/or TL4 for a given TTI/TFRE responsive to CQI/PCI feedback from wireless terminal 200 as discussed above with respect to FIGS. 3A and 3B. In addition, base station processor may transmit rank and/or precoding vector information (identifying the selected MIMO rank) to wireless terminal 200 via downlink signaling as discussed above with respect to FIG. 3A. For example, a higher MIMO rank (defining a respective higher number of transmission layers/streams) may be selected when the wireless terminal detects that the downlink channel has a higher SINR (e.g., when the wireless terminal is relatively close to the base station), and a lower MIMO rank (defining a respective lower number of transmission layers/streams) may be selected when the wireless terminal detects that the downlink channel has a lower SINR (e.g., when the wireless terminal is relatively distant from the base station).

Upon reception of ACK/NACK/CSI feedback from wireless terminal 200 through transceiver 109 at block 1201, processor 101 may select transmission/retransmission, rank, and precoding vector for wireless terminal 200 for a next transmission time interval at block 1203. Processor 101 may proceed at block 1205 according to the selected rank (identifying the number of transmission layers/streams for the TTI).

For rank 1 transmission, processor 101 may map the first HARQ process HARQ-1 to a tenth data block of the first transmission layer TL1 for a rank 1 TTI at block 1211. At block 1221, mapping the first HARQ process HARQ-1 to the data block of the rank 1 TTI may include transmitting a single bit data indicator indicating an initial transmission or a retransmission of the data block. At block 1231, processor 101 may transmit the data block using the first transmission layer TL1 during the rank 1 transmission time interval.

For rank 2 transmission, processor 101 may map HARQ-1 to a first data block of the first transmission layer TL1 for a rank 2 TTI at block 1213, and processor 101 may map HARQ-2 to a second data block of the second transmission layer TL2 for the rank 2 TTI at block 1213. At block 1223, mapping the first HARQ process HARQ-1 to the first data block of the rank 2 TTI may include transmitting a single bit data indicator indicating an initial transmission or a retransmission of the first data block, and mapping the second HARQ process HARQ-2 to the second data block of the rank 2 TTI may include transmitting a single bit data indicator indicating an initial transmission or a retransmission of the second data block. At block 1233, processor 101 may transmit the first and second data blocks using the first and second transmission layers TL1 and TL2 during the rank 2 transmission time interval.

For rank 3 transmission, processor 101 may map HARQ-1 to a first data block of the first transmission layer TL1 for a rank 3 TTI at block 1215, and processor 101 may map HARQ-2 to second and third data blocks of second and third transmission layers TL2 and TL3 for the rank 3 TTI at block 1215. At block 1225, mapping HARQ-1 to the first data block of the rank 3 TTI may include transmitting a single bit data indicator indicating an initial transmission or a retransmission of the first data block, and mapping HARQ-2 to the second and third data blocks of the rank 3 TTI may include transmitting a single bit data indicator indicating an initial transmission or a retransmission of the second and third data blocks. At block 1235, processor 101 may transmit the first, second, and third data blocks using the first, second, and third transmission layers TL1, TL2, and TL3 during the rank 3 transmission time interval.

For rank 4 transmission, processor 101 may map HARQ-1 to a first and fourth data blocks of the first and fourth transmission layers TL1 and TL4 for a rank 4 TTI at block 1217, and processor 101 may map HARQ-2 to second and third data blocks of second and third transmission layers TL2 and TL3 for the rank 4 TTI at block 1217. At block 1227, mapping HARQ-1 to the first and fourth data blocks of the rank 4 TTI may include transmitting a single bit data indicator indicating an initial transmission or a retransmission of the first and fourth data blocks, and mapping HARQ-2 to the second and third data blocks of the rank 4 TTI may include transmitting a single bit data indicator indicating an initial transmission or a retransmission of the second and third data blocks. At block 1237, processor 101 may transmit the first, second, third, and fourth data blocks using the first, second, third, and fourth transmission layers TL1, TL2, TL3, and TL4 during the rank 4 transmission time interval.

As further shown in FIG. 12, the rank may be dynamically assigned over the course of a communication between the wireless terminal 200 and base station 100, with different MIMO ranks used during different transmission time intervals.

### ACRONYMS/ABBREVIATIONS

MIMO Multiple Input Multiple Output

Tx Transmitter

HSDPA High Speed Downlink Packet Access

HARQ Hybrid Automatic Repeat Request

CRC Cyclic Redundancy Check

NAK/NACK Non-Acknowledgment or Negative-Acknowledgment

ACK Acknowledgment

CC Chase Combining

IR Incremental Redundancy

UE User Equipment or Wireless Terminal

CQI Channel Quality Information

MMSE Minimum Mean Square Error

TTI Transmit Time Interval

PCI Precoding Control Index

In the above-description of various embodiments of present inventive concepts, it is to be understood that the terminology used herein is for the purpose of describing particular embodiments only and is not intended to be limiting of the inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. The same reference numerals or the same reference designators denote the same or similar elements throughout the specification.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks.

A tangible, non-transitory computer-readable medium may include an electronic, magnetic, optical, electromagnetic, or semiconductor data storage system, apparatus, or device. More specific examples of the computer-readable medium would include the following: a portable computer diskette, a random access memory (RAM) circuit, a read-only memory (ROM) circuit, an erasable programmable read-only memory (EPROM or Flash memory) circuit, a portable compact disc read-only memory (CD-ROM), and a portable digital video disc read-only memory (DVD/BlueRay).

The computer program instructions may also be loaded onto a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of present inventive concepts. Moreover, although some of the diagrams include arrows on communication paths to show a primary direction of communication, it is to be understood that communication may occur in the opposite direction to the depicted arrows.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of various example combinations and subcombinations of embodiments and of the manner and process of making and using them, and shall support claims to any such combination or subcombination.

Many variations and modifications can be made to the embodiments without substantially departing from the principles of present inventive concepts. All such variations and modifications are intended to be included herein within the scope of present inventive concepts. Accordingly, the above disclosed subject matter is to be considered illustrative, and not restrictive, and the appended claims are intended to cover all such modifications, enhancements, and other embodiments, which fall within the spirit and scope of present inventive concepts. Thus, to the maximum extent allowed by law, the scope of present inventive concepts is to be determined by the broadest permissible interpretation of the embodiments discussed herein, and shall not be restricted or limited by the foregoing and/or following detailed description.

1. A method of operating a communications device supporting multiple-input-multiple-output, MIMO, reception over a wireless channel, the method comprising:
receiving first and second data blocks respectively using first and second reception layers during a first transmission time interval, TTI, for rank two reception;
mapping a first Hybrid Automatic Repeat Request, HARQ, process to the first data block of the first reception layer for the first transmission time interval and mapping a second HARQ process to the second data block of the second reception layer for the first TTI;
receiving third, fourth, and fifth data blocks respectively using the first and second reception layers and using a third reception layers during a second TTI for rank three reception; and
mapping the first HARQ process to the third data block of the first reception layer for the second TTI and mapping the second HARQ process to the fourth and fifth data blocks of the second and third reception layers for the second TTI.

2. The method according to claim 1, the method further comprising:
receiving sixth, seventh, eighth, and ninth data blocks respectively using the first, second, and third receptions layers and using a fourth reception layers during a third TTI for rank four reception; and
mapping the first HARQ process to the sixth and ninth data blocks of the first and fourth reception layers for the third TTI and mapping the second HARQ process to the seventh and eighth data blocks of the second and third reception layers for the third TTI.

3. The method according to claim 2, the method further comprising:
receiving a tenth data block using the first reception layer during a fourth transmission time interval for rank one reception; and
mapping the first HARQ process to the tenth data block of the first reception layer for the fourth transmission time interval.

4. (canceled)

5. The method according to claim 1,
wherein the communication device comprises a wireless terminal,
wherein mapping the first HARQ process to the first data block of the first TTI comprises transmitting an acknowledgment, ACK, message to the radio access network responsive to success decoding the first data block and transmitting a non-acknowledgment, NACK, message to the radio access network responsive to failure decoding the first data block, and
wherein mapping the second HARQ process to the second data block for the first TTI comprises transmitting an ACK message to the radio access network responsive to success decoding the second data block and transmitting a NACK message to the radio access network responsive to failure decoding the second data block.

6. The method according to claim 5 further comprising:
selecting a precoding vector responsive to success and/or failure decoding the first and second data blocks; and
transmitting an identification of the selected precoding vector to the radio access network.

7. The method according to claim 6 wherein selecting comprises,
defining a search space for precoding vectors to include a plurality of precoding vectors of a precoding code book responsive to success decoding all of the first and second data blocks received during the first transmission time interval,
defining a search space for precoding vectors to include fewer than all of the plurality of precoding vectors of the precoding codebook responsive to failure decoding at least one of the first and second data blocks during the first transmission time interval, and
selecting the precoding vector from the defined search space.

8. The method according to claim 5,
wherein mapping the first HARQ process to the third data block of the second TTI comprises transmitting an ACK message to the radio access network responsive to success decoding the third data block and transmitting a NACK message responsive to failure decoding the third data block, and
wherein mapping the second HARQ process to the fourth and fifth data blocks of the second transmission time interval comprises transmitting an ACK message to the radio access network responsive to success decoding both of the fourth and fifth data blocks and transmitting a NACK message responsive to failure decoding either or both of the fourth and fifth data blocks.

9. The method according to claim 2,
wherein the communication device comprises a wireless terminal,
wherein mapping the first HARQ process to the sixth and ninth data blocks of the third TTI comprises transmitting an ACK message to the radio access network responsive to success decoding both of the sixth and ninth data blocks and transmitting a NACK message to the radio access network responsive to failure decoding either or both of the sixth and ninth data blocks, and
wherein mapping the second HARQ process to the seventh and eighth data blocks of the third transmission time interval comprises transmitting an ACK message to the radio access network responsive to success decoding both of the seventh and eighth data blocks and transmitting a NACK message to the radio access network responsive to failure decoding either or both of the seventh and eighth data blocks.

10. (canceled)

11. A method of operating a communication device receiving communications over a wireless channel, the method comprising:
receiving at least one data block from a second communication device during a transmission time interval, TTI, over at least one of a plurality of reception layers;
responsive to success decoding all of the at least one data blocks received during the transmission time interval, defining a search space for precoding vectors to include a plurality of precoding vectors of a precoding codebook;
responsive to failure decoding at least one of the at least one data blocks during the transmission time interval, defining a search space for precoding vectors to include fewer than all of the plurality of precoding vectors of the precoding codebook;
selecting one of the precoding vectors from the defined search space; and
transmitting an identification of the selected precoding vector to the second communication device.

12. The method according to claim 11 wherein the plurality of precoding vectors of the precoding codebook are grouped into respective ranks wherein each rank corresponds to a number of reception layers used to receive respective data blocks during a transmission time interval.

13. The method according to claim 12, wherein defining the search space to include the plurality of precoding vectors comprises defining the search space to include all of the ranks of precoding vectors, and wherein defining the search space to include fewer than all of the precoding vectors comprises restricting the search space to fewer than all of the ranks of precoding vectors.

14. The method according to claim 12 wherein the precoding codebook includes a first rank of precoding vectors for reception using only a first reception layer to receive only one data block during a rank one transmission time interval, a second rank of precoding vectors for reception using only first and second reception layers to receive only two data blocks during a rank two transmission time interval, a third rank of precoding vectors for reception using only first, second, and third reception layers to receive only three data blocks during a rank three transmission time interval, and a fourth rank of precoding vectors for reception using first, second, third, and fourth reception layers to receive four data blocks during a rank four transmission time interval.

15. The method according to claim 11 wherein selecting one of the precoding vectors comprises computing a performance of each of the precoding vectors of the defined search space, and wherein selecting one of the precoding vectors comprises selecting one of the precoding vectors from the defined search space responsive to the computed performances.

16. The method according to claim 11 wherein defining the search space to include fewer than all of the plurality of precoding vectors comprises excluding some of the plurality of precoding vectors from the defined search space.

17. (canceled)

18. A communications device comprising:
a transceiver configured to receive multiple-input-multiple-output, MIMO, reception over a wireless channel; and
a processor coupled to the transceiver, wherein the processor is configured to receive first and second data blocks through the transceiver respectively using first and second reception layers during a first transmission time interval, TTI, for rank two reception, wherein the processor is configured to map a first Hybrid Automatic Repeat Request, HARQ, process to the first data block of the first reception layer for the first transmission time interval and to map a second HARQ process to the second data block of the second reception layer for the first TTI, wherein the processor is configured to receive third, fourth, and fifth data blocks through the transceiver respectively using the first and second reception layers and a third reception layers during a second TTI for rank three reception, and wherein the processor is configured to map the first HARQ process to the third data block of the first reception layer for the second TTI and to map the second HARQ process to the fourth and fifth data blocks of the second and third reception layers for the second TTI.

19. The communications device according to claim 18, wherein the processor is configured to receive sixth, seventh, eighth, and ninth data blocks respectively using the first, second, and third reception layers and a fourth reception layers during a third TTI for rank four reception, and wherein the processor is configured to map the first HARQ process to the sixth and ninth data blocks of the first and fourth reception layers for the third TTI and to map the second HARQ process to the seventh and eighth data blocks of the second and third reception layers for the third TTI.

20. (canceled)

21. (canceled)

22. A communication device comprising:
a transceiver configured to receive multiple-input-multiple-output, MIMO, communications over a wireless channel; and
a processor coupled to the transceiver, wherein the processor is configured to receive at least one data block through the transceiver from a second communication device over at least one of a plurality of MIMO reception layers during a transmission time interval, to define a search space for precoding vectors to include a plurality of precoding vectors of a precoding code book responsive to success decoding all of the at least one data blocks received during the transmission time interval, to define a search space for precoding vectors to include fewer than all of the plurality of precoding vectors of the precoding codebook responsive to failure decoding at least one of the at least one data blocks during the transmission time interval, to select one of the precoding vectors from the defined search space, and to transmit an identification of the selected precoding vector through the transceiver to the second communication device.

23. (canceled)

24. A method of operating a communications device supporting multiple-input-multiple-output, MIMO, transmission over a wireless channel, the method comprising:
mapping a first Hybrid Automatic Repeat Request, HARQ, process to a first data block of a first transmission layer for a first transmission time interval, TTI, and mapping a second HARQ process to a second data block of a second transmission layer for the first TTI;
transmitting the first and second data blocks respectively using the first and second transmission layers during the first TTI for the rank two transmission;
mapping the first HARQ process to a third data block of the first transmission layer for a second TTI and mapping the second HARQ process to fourth and fifth data blocks of the second transmission layer and a third transmission layer for the second TTI; and
transmitting the third, fourth, and fifth data blocks respectively using the first, second, and third transmission layers during the second TTI for the rank three transmission.

25. The method according to claim 24 further comprising:
mapping the first HARQ process to sixth and ninth data blocks of the first transmission layer and a fourth transmission layer for a third TTI and mapping the second HARQ process to seventh and eighth data blocks of the second and third transmission layers for the third TTI for a rank four transmission; and
transmitting the sixth, seventh, eighth, and ninth data blocks respectively using the first, second, third, and fourth transmission layers during the third TTI for the rank four transmission.

26. The method according to claim 24 further comprising:
mapping the first HARQ process to a tenth data block of the first transmission layer for a fourth TTI for a rank one transmission; and
transmitting the tenth data block using the first transmission layer during the fourth transmission time interval for the rank one transmission.

27. (canceled)

28. The method according to claim 24,
wherein mapping the first HARQ process to the first data block of the first TTI comprises transmitting a single bit data indicator indicating an initial transmission or a retransmission of the first data block, and
wherein mapping the second HARQ process to the second data block of the first TTI comprises transmitting a single bit data indicator indicating an initial transmission or a retransmission of the second data block.

29. The method according to claim 24,
wherein mapping the first HARQ process to the third data block of the second TTI comprises transmitting a single bit data indicator indicating an initial transmission or a retransmission of the third data block, and
wherein mapping the second HAR process to the fourth and fifth data blocks of the second TTI comprises transmitting a single bit data indicator indicating an initial transmission or a retransmission of the fourth and fifth data blocks.

30. The method according to claim 25,
wherein mapping the first HARQ process to the sixth and ninth data blocks of the third TTI comprises transmitting a single bit data indicator indicating an initial transmission or a retransmission of the sixth and ninth data blocks, and
wherein mapping the second HARQ process to the seventh and eighth data blocks of the third TTI comprises transmitting a single bit data indicator indicating an initial transmission or a retransmission of the seventh and eighth data blocks.

31. (canceled)

32. A communications device comprising:
a transceiver configured to transmit multiple-input-multiple-output, MIMO, transmissions over a wireless channel; and
a processor coupled to the transceiver, wherein the processor is configured to transmit first and second data blocks through the transceiver respectively using first and second transmission layers during a first transmission time interval, TTI, for rank two transmission, wherein the processor is configured to map a first Hybrid Automatic Repeat Request, HARQ, process to the first data block of the first transmission layer for the first transmission time interval and to map a second HARQ process to the second data block of the second transmission layer for the first TTI, wherein the processor is configured to transmit third, fourth, and fifth data blocks through the transceiver respectively using the first and second transmission layers and a third transmission layer during a second TTI for rank three transmission, and wherein the processor is configured to map the first HARQ process to the third data block of the first transmission layer for the second TTI and to map the second HARQ process to the fourth and fifth data blocks of the second and third transmission layers for the second TTI.

33. The communications device according to claim 32, wherein the processor is configured to transmit sixth, seventh, eighth, and ninth data blocks respectively using the first, second, and third transmission layers and a fourth transmission layer during a third TTI for rank four transmission, and wherein the processor is configured to map the first HARQ process to the sixth and ninth data blocks of the first and fourth transmission layers for the third TTI and to map the second HARQ process to the seventh and eighth data blocks of the second and third transmission layers for the third TTI.

34. (canceled)

35. (canceled)
